(19) United States
(12) Patent Application Publication
(10) Pub. No.: US 2025/0292781 A1
(43) Pub. Date: Sep. 18, 2025

(54) Scene Audio Encoding Method and Electronic Device

(71) Applicant: Huawei Technologies Co., Ltd., Shenzhen (CN)

(72) Inventors: Yuan Gao, Beijing (CN); Shuai Liu, Beijing (CN); Bingyin Xia, Beijing (CN); Zhe Wang, Beijing (CN)

(21) Appl. No.: 19/224,052

(22) Filed: May 30, 2025

Related U.S. Application Data
(63) Continuation of application No. PCT/CN2023/131640, filed on Nov. 14, 2023.

(30) Foreign Application Priority Data
Dec. 2, 2022 (CN) 202211537851.0

(51) Int. Cl. G10L 19/008

(52) U.S. Cl. CPC G10L 19/008

(57) ABSTRACT

A scene audio encoding method includes obtaining a to-be-encoded scene audio signal, where the scene audio signal includes an audio signal with C1 channels, determining attribute information of a target virtual speaker based on the scene audio signal, and encoding a first audio signal in the scene audio signal and the attribute information to obtain a first bitstream. The first audio signal is an audio signal with K channels in the scene audio signal, and K is a positive integer less than or equal to C1.

### CROSS-REFERENCE TO RELATED APPLICATIONS

This is a continuation of International Patent Application No. PCT/CN2023/131640, filed on Nov. 14, 2023, which claims priority to Chinese Patent Application No. 202211537851.0, filed on Dec. 2, 2022. The disclosures of the aforementioned applications are hereby incorporated by reference in their entireties.

### TECHNICAL FIELD

Embodiments of this disclosure relate to the audio encoding and decoding field, and in particular, to a scene audio encoding method and an electronic device.

### BACKGROUND

A three-dimensional audio technology is an audio technology for obtaining, processing, transmitting, rendering, and playing back sound events and three-dimensional sound field information in the real world through a computer, signal processing, or the like. Three-dimensional audio makes a sound have a strong sense of space, envelopment, and immersion, and provides people with extraordinary “immersive” auditory experience. In a higher-order Ambisonics (HOA) technology, recording, encoding, and playback stages are unrelated to a speaker layout, data in a HOA format is rotatably played back, and there is higher flexibility in playback of the three-dimensional audio. Therefore, there is more extensive attention and research.

A quantity of channels corresponding to an N-order HOA signal is (N+1)². As an HOA order quantity increases, information used to record a more detailed sound scene in an HOA signal increases accordingly. However, a data amount of the HOA signal also increases accordingly, and a large amount of data makes it difficult to transmit and store the HOA signal. Therefore, the HOA signal needs to be encoded and decoded. However, encoding performance of the HOA signal is low in some technologies.

### SUMMARY

This disclosure provides a scene audio encoding method and an electronic device.

According to a first aspect, an embodiment provides a scene audio encoding method. The method includes: obtaining a to-be-encoded scene audio signal, where the scene audio signal includes an audio signal with C1 channels, and C1 is a positive integer; determining attribute information of a target virtual speaker based on the scene audio signal; and encoding a first audio signal in the scene audio signal and the attribute information of the target virtual speaker, to obtain a first bitstream. The first audio signal is an audio signal with K channels in the scene audio signal, and K is a positive integer less than or equal to C1.

It should be noted that a location of the target virtual speaker matches a location of a sound source in the scene audio signal; a virtual speaker signal corresponding to the target virtual speaker may be generated based on the attribute information of the target virtual speaker and the first audio signal in the scene audio signal; and the scene audio signal may be reconstructed based on the virtual speaker signal. Therefore, an encoder side encodes the first audio signal in the scene audio signal and the attribute information of the target virtual speaker, and then sends the encoded first audio signal and the encoded attribute information to a decoder side. The decoder side may reconstruct the scene audio signal based on a first reconstructed signal (namely, a reconstructed signal of the first audio signal in the scene audio signal) and the attribute information of the target virtual speaker that are obtained through decoding.

Compared with another scene audio signal reconstruction method in some technologies, audio quality of the scene audio signal reconstructed based on a virtual speaker signal is higher. Therefore, when K is equal to C1, the audio quality of the scene audio signal reconstructed is higher at a same bit rate.

When K is less than C1, compared with some technologies, a quantity of channels of an encoded audio signal is smaller, and a data amount of the attribute information of the target virtual speaker is far less than a data amount of an audio signal with one channel. Therefore, an encoding bit rate is lower while same quality is achieved.

In addition, in some technologies, the scene audio signal is converted into a virtual speaker signal and a residual signal, and then encoded. In this disclosure, the encoder side directly encodes the first audio signal in the scene audio signal, without a need to calculate the virtual speaker signal and the residual signal. In this way, encoding complexity of the encoder side is lower.

For example, the scene audio signal in this embodiment may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal.

In a possible manner, when N1 is equal to 1, K may be equal to C1; or when N1 is greater than 1, K may be less than C1. It should be understood that when N1 is equal to 1, K may alternatively be less than C1.

For example, a process of encoding the first audio signal in the scene audio signal and the attribute information of the target virtual speaker may include operations such as downmixing, transformation, quantization, and entropy encoding. This is not limited in this disclosure.

For example, the first bitstream may include encoded data of the first audio signal in the scene audio signal and encoded data of the attribute information of the target virtual speaker.

In a possible manner, the target virtual speaker may be selected from a plurality of candidate virtual speakers based on the scene audio signal, and then attribute information of the target virtual speaker is determined. For example, the virtual speaker (including a candidate virtual speaker and a target virtual speaker) is a speaker that is virtual, rather than a speaker that actually exists.

For example, the plurality of candidate virtual speakers may be evenly distributed on a spherical surface, and there may be one or more target virtual speakers.

In a possible manner, a preset target virtual speaker may be obtained, and then the attribute information of the target virtual speaker is determined.

It should be understood that a manner of determining the target virtual speaker is not limited in this disclosure.

According to the first aspect, the scene audio signal is an N1-order HOA signal, the N1-order HOA signal includes a second audio signal and a third audio signal, the second audio signal is a 0^{th}-order HOA signal to an M^{th}-order HOA signal in the N1-order HOA signal, the third audio signal is an audio signal in the N1-order HOA signal other than the second audio signal, M is an integer less than N1, C1 is equal to a square of (N1+1), and N1 is a positive integer. The first audio signal includes the second audio signal.

For example, that the first audio signal includes the second audio signal may be understood as that the first audio signal includes only the second audio signal.

For example, that the first audio signal includes the second audio signal may be understood as that the first audio signal includes the second audio signal and another audio signal.

According to any one of the first aspect or the foregoing implementations of the first aspect, the first audio signal further includes a fourth audio signal. The fourth audio signal is an audio signal with some channels in the third audio signal.

The first audio signal may include an audio signal with an even quantity of channels. When a quantity of channels of the second audio signal is an odd number, a quantity of channels of the fourth audio signal may also be an odd number. In this way, an encoder that supports encoding of only an audio signal with an even quantity of channels can perform encoding.

For example, the second audio signal may be referred to as a low-order part of the scene audio signal, and the third audio signal may be referred to as a high-order part of the scene audio signal. The low-order part of the scene audio signal and a part of the high-order part of the scene audio signal may be encoded, to ensure that the first audio signal includes the audio signal with the even quantity of channels.

It should be understood that the first audio signal may alternatively include an audio signal with an odd quantity of channels. When a quantity of channels of the second audio signal is an even number, a quantity of channels of the fourth audio signal may be an odd number. In this way, an encoder that supports encoding of only an audio signal with an odd quantity of channels can perform encoding.

It should be understood that, compared with a case in which the first audio signal includes the second audio signal and the fourth audio signal, when the first audio signal includes only the second audio signal, a quantity of channels of the encoded first audio signal is smaller, and a corresponding bit rate is lower.

According to any one of the first aspect or the foregoing implementations of the first aspect, the attribute information of the target virtual speaker includes at least one of the following: location information of the target virtual speaker, a location index corresponding to the location information of the target virtual speaker, or a virtual speaker index of the target virtual speaker.

For example, in a spherical coordinate system, the location information of the target virtual speaker may be, for example, (θₛ₃, φₛ₃). Herein, θₛ₃ is horizontal angle information of the target virtual speaker, and φₛ₃ is pitch angle information of the target virtual speaker.

For example, the location index is used to uniquely identify a location of a virtual speaker. The location index may include a horizontal angle index (used to uniquely identify one piece of horizontal angle information) and a pitch angle index (used to uniquely identify one piece of pitch angle information). The location index of the virtual speaker is in a one-to-one correspondence with location information of the virtual speaker.

For example, the virtual speaker index may be used to uniquely identify a virtual speaker, and the location information/location index of the virtual speaker is in a one-to-one correspondence with the virtual speaker index.

According to any one of the first aspect or the foregoing implementations of the first aspect, determining the attribute information of the target virtual speaker based on the scene audio signal includes: obtaining a plurality of groups of virtual speaker coefficients corresponding to the plurality of candidate virtual speakers, where the plurality of groups of virtual speaker coefficients are in a one-to-one correspondence with the plurality of candidate virtual speakers; selecting the target virtual speaker from the plurality of candidate virtual speakers based on the scene audio signal and the plurality of groups of virtual speaker coefficients; and obtaining the attribute information of the target virtual speaker.

When each candidate virtual speaker serves as a virtual sound source, a virtual speaker signal generated by the virtual sound source has a plane wave, and the plane wave may be expanded in the spherical coordinate system. For an ideal plane wave whose amplitude is s and direction is (θₛ, φₛ), a form obtained through expansion based on a spherical harmonic function may be shown in Formula (3). (θₛ, φₛ) in Formula (3) is set as the location information (θₛ₃, φₛ₃) of the candidate virtual speaker. In this case, B_{m,n}^{σ} shown in Formula (3) is a group of virtual speaker coefficients (namely, HOA coefficients). That is, the virtual speaker coefficient is also an HOA coefficient. It should be noted that, it can be learned from Formula (3) that when a location of the candidate virtual speaker is different from the location of the sound source in the scene audio signal, the virtual speaker coefficient of the candidate virtual speaker and the scene audio signal are different HOA coefficients.

In this way, a target virtual speaker whose location matches the location of the sound source in the scene audio signal can be accurately found from the plurality of candidate virtual speakers based on the scene audio signal and the plurality of groups of virtual speaker coefficients.

According to any one of the first aspect or the foregoing implementations of the first aspect, selecting the target virtual speaker from the plurality of candidate virtual speakers based on the scene audio signal and the plurality of groups of virtual speaker coefficients includes: obtaining a dot product of the scene audio signal and each of the plurality of groups of virtual speaker coefficients, to obtain a plurality of dot product values, where the plurality of dot product values are in a one-to-one correspondence with the plurality of groups of virtual speaker coefficients; and selecting the target virtual speaker from the plurality of candidate virtual speakers based on the plurality of dot product values. In this way, a matching degree between each candidate virtual speaker and the scene audio signal can be accurately determined based on the dot product, and further, a target virtual speaker whose location better matches the location of the sound source in the scene audio signal can be selected.

According to any one of the first aspect or the foregoing implementations of the first aspect, the method further includes: obtaining feature information that corresponds to a fifth audio signal and that is in the scene audio signal; and encoding the feature information, to obtain a second bitstream. The fifth audio signal is the third audio signal, or the fifth audio signal is an audio signal in the scene audio signal other than the second audio signal and the fourth audio signal, and the fourth audio signal is an audio signal with some channels in the third audio signal. The feature information may be used to compensate an audio signal with some channels in the reconstructed scene audio signal in a decoding process of the decoder side, to improve audio quality of the audio signal with the some channels in the reconstructed scene audio signal.

A data amount of the feature information is small. Therefore, compared with some technologies, even if the feature information is encoded, a total bit rate is smaller. Therefore, audio quality of the reconstructed scene audio signal can be further improved at a same bit rate.

For example, the feature information that corresponds to the fifth audio signal and that is in the scene audio signal may be determined based on information such as energy and strength of the scene audio signal.

According to any one of the first aspect or the foregoing implementations of the first aspect, the feature information includes gain information.

For example, the feature information may further include diffusion information, and the like. This is not limited in this disclosure.

According to a second aspect, an embodiment provides a scene audio decoding method. The scene audio decoding method includes: receiving a first bitstream; decoding the first bitstream, to obtain a first reconstructed signal and attribute information of a target virtual speaker, where the first reconstructed signal is a reconstructed signal of a first audio signal in a scene audio signal, the scene audio signal includes an audio signal with C1 channels, the first audio signal is an audio signal with K channels in the scene audio signal, C1 is a positive integer, and K is a positive integer less than or equal to C1; generating, based on the attribute information and the first reconstructed signal, a virtual speaker signal corresponding to the target virtual speaker; and performing reconstruction based on the attribute information and the virtual speaker signal, to obtain a first reconstructed scene audio signal, where the first reconstructed scene audio signal includes an audio signal with C2 channels, and C2 is a positive integer.

Compared with another scene audio signal reconstruction method in some technologies, audio quality of the scene audio signal reconstructed based on a virtual speaker signal is higher. Therefore, when K is equal to C1, the audio quality of the scene audio signal reconstructed is higher at a same bit rate.

When K is less than C1, in a process of encoding the scene audio signal, a quantity of channels of an encoded audio signal is less than a quantity of channels of an encoded audio signal in some technologies, and a data amount of the attribute information of the target virtual speaker is far less than a data amount of an audio signal with one channel. Therefore, audio quality of the reconstructed scene audio signal obtained through decoding is higher at a same bit rate.

Because a virtual speaker signal and residual information that are encoded and transmitted in some technologies are converted from an original audio signal (namely, a to-be-encoded scene audio signal) and are not an original audio signal, an error is introduced. However, some original audio signals (namely, an audio signal with K channels in the to-be-encoded scene audio signal) are encoded, to avoid introducing an error and improve audio quality of the reconstructed scene audio signal obtained through decoding. In addition, a fluctuation of reconstruction quality of the reconstructed scene audio signal obtained through decoding can be avoided, and stability is high.

In addition, because the virtual speaker signal is encoded and transmitted in some technologies, and a data amount of the virtual speaker signal is large, a quantity of target virtual speakers selected in some technologies is greatly limited by a bandwidth. In this disclosure, attribute information of a virtual speaker is encoded and transmitted, and a data amount of the attribute information is far less than the data amount of a virtual speaker signal. Therefore, a quantity of target virtual speakers selected is less limited by a bandwidth. A larger quantity of selected target virtual speakers indicates higher quality of a scene audio signal reconstructed based on a virtual speaker signal of the target virtual speaker. Therefore, compared with some technologies, more target virtual speakers may be selected at a same bit rate. In this way, quality of the reconstructed scene audio signal obtained through decoding is higher.

In addition, both an encoder side and a decoder side are considered. Compared with an encoder side and a decoder side in some technologies, an encoder side and a decoder side do not need to perform residual and superimposition operations. Therefore, comprehensive complexity of the encoder side and the decoder side is lower than comprehensive complexity of the encoder side and the decoder side in some technologies.

It should be understood that, when the encoder side performs lossy compression on the first audio signal in the scene audio signal, there is a difference between a first reconstructed signal obtained by the decoder side through decoding and the first audio signal encoded by the encoder side. When the encoder side performs lossless compression on the first audio signal, a first reconstructed signal obtained by the decoder side through decoding is the same as the first audio signal encoded by the encoder side.

It should be understood that, when the encoder side performs lossy compression on the attribute information of the target virtual speaker, there is a difference between attribute information obtained by the decoder side through decoding and the attribute information encoded by the encoder side. When the encoder side performs lossless compression on the attribute information of the virtual speaker, attribute information obtained by the decoder side through decoding is the same as the attribute information encoded by the encoder side. (In this disclosure, the attribute information encoded by the encoder side and the attribute information obtained by the decoder side through decoding are not distinguished by name.)

According to a second aspect, the method further includes: generating a second reconstructed scene audio signal based on the first reconstructed signal and the first reconstructed scene audio signal. The second reconstructed scene audio signal includes an audio signal with C2 channels. The first reconstructed signal obtained through decoding is closer to the encoded first audio signal than an audio signal corresponding to a channel in the first reconstructed scene audio signal and an audio signal corresponding to a channel in the first audio signal. In this way, a second reconstructed scene audio signal whose audio quality is higher than that of the first reconstructed scene audio signal can be obtained.

According to any one of the second aspect or the implementations of the second aspect, the scene audio signal is an N1-order HOA signal, the N1-order HOA signal includes a second audio signal and a third audio signal, the second audio signal is a 0^{th}-order signal to an M^{th}-order signal in the N1-order HOA signal, the third audio signal is an audio signal in the N1-order HOA signal other than the second audio signal, M is an integer less than N, C1 is equal to a square of (N1+1), and N1 is a positive integer.

The first reconstructed scene audio signal is an N2-order HOA signal, the N2-order HOA signal includes a sixth audio signal and a seventh audio signal, the sixth audio signal is a 0^{th}-order signal to an M^{th}-order signal in the N2-order HOA signal, the seventh audio signal is an audio signal in the N2-order HOA signal other than the sixth audio signal, M is an integer less than N2, C2 is equal to a square of (N2+1), and N2 is a positive integer.

Generating the second reconstructed scene audio signal based on the first reconstructed signal and the first reconstructed scene audio signal includes: generating the second reconstructed scene audio signal based on a second reconstructed signal and the seventh audio signal when the first audio signal includes the second audio signal. The second reconstructed signal is a reconstructed signal of the second audio signal.

The first reconstructed signal obtained through decoding is closer to the first audio signal encoded by the encoder side than the audio signal corresponding to the channel in the first reconstructed scene audio signal and the audio signal corresponding to the channel in the first audio signal. Therefore, audio quality of the second reconstructed scene audio signal obtained based on the first reconstructed signal and the seventh audio signal is higher.

According to any one of the second aspect or the foregoing implementations of the second aspect, generating the second reconstructed scene audio signal based on the first reconstructed signal and the first reconstructed scene audio signal includes: generating the second reconstructed scene audio signal based on a second reconstructed signal, a fourth reconstructed signal, and an eighth audio signal when the first audio signal includes the second audio signal and a fourth audio signal. The fourth audio signal is a partial audio signal in the third audio signal, the fourth reconstructed signal is a reconstructed signal of the fourth audio signal, the second reconstructed signal is a reconstructed signal of the second audio signal, and the eighth audio signal is a partial audio signal in the seventh audio signal.

In this way, a quantity of channels of a first reconstructed signal in the second reconstructed scene audio signal obtained in this manner is greater than a quantity of channels of a first reconstructed signal in the second reconstructed scene audio signal generated based on the second reconstructed signal and the seventh audio signal. Therefore, the obtained second reconstructed scene audio signal is closer to the encoded scene audio signal, and the obtained second reconstructed scene audio signal has higher audio quality.

According to any one of the second aspect or the foregoing implementations of the second aspect, generating, based on the attribute information and the first reconstructed signal, the virtual speaker signal corresponding to the target virtual speaker includes: determining, based on the attribute information, a first virtual speaker coefficient corresponding to the target virtual speaker; and generating the virtual speaker signal based on the first reconstructed signal and the first virtual speaker coefficient. In this way, the virtual speaker signal can be generated.

According to any one of the second aspect or the foregoing implementations of the second aspect, performing reconstruction based on the attribute information and the virtual speaker signal, to obtain the first reconstructed scene audio signal includes: determining, based on the attribute information, a second virtual speaker coefficient corresponding to the target virtual speaker; and obtaining the first reconstructed scene audio signal based on the virtual speaker signal and the second virtual speaker coefficient. In this way, a scene audio signal can be reconstructed.

According to any one of the second aspect or the foregoing implementations of the second aspect, before generating the second reconstructed scene audio signal based on the second reconstructed signal and the seventh audio signal, the method further includes: receiving a second bitstream; decoding the second bitstream, to obtain feature information that corresponds to a fifth audio signal and that is in the scene audio signal, where the fifth audio signal is the third audio signal; and compensating the seventh audio signal based on the feature information. In this way, the seventh audio signal in the first reconstructed scene audio signal obtained through reconstruction is compensated, so that audio quality of the seventh audio signal in the first reconstructed scene audio signal obtained through reconstruction can be improved.

It should be understood that, when the encoder side performs lossy compression on feature information, there is a difference between feature information obtained by the decoder side through decoding and the feature information encoded by the encoder side. When the encoder side performs lossless compression on feature information, feature information obtained by the decoder side through decoding is the same as the feature information encoded by the encoder side. (In this disclosure, feature information encoded by the encoder side and feature information obtained by the decoder side through decoding are not distinguished by name.)

According to any one of the second aspect or the foregoing implementations of the second aspect, before generating the second reconstructed scene audio signal based on the second reconstructed signal, the fourth reconstructed signal, and the eighth audio signal, the method further includes: receiving a second bitstream; decoding the second bitstream, to obtain feature information that corresponds to a fifth audio signal and that is in the scene audio signal, where the fifth audio signal is an audio signal in the scene audio signal other than the second audio signal and the fourth audio signal; and compensating the eighth audio signal based on the feature information. In this way, the eighth audio signal in the first reconstructed scene audio signal obtained through reconstruction is compensated, so that audio quality of the eighth audio signal in the first reconstructed scene audio signal obtained through reconstruction can be improved.

It should be understood that, regardless of whether an operation of generating the second reconstructed scene audio signal based on the first reconstructed signal and the first reconstructed scene audio signal is performed, after the first reconstructed scene audio signal is obtained, the seventh audio signal/the eighth audio signal in the first reconstructed scene audio signal may be compensated based on the feature information, to improve the first reconstructed scene audio signal.

According to any one of the second aspect or the foregoing implementations of the second aspect, the feature information includes gain information.

For example, the second reconstructed scene audio signal may be an N2-order HOA signal. N2 is a positive integer. For example, the N2-order HOA signal may include an audio signal with C2 channels. C2=(N2+1)².

For example, an order quantity N2 of the second reconstructed scene audio signal may be greater than or equal to an order quantity N1 of the scene audio signal. Correspondingly, a quantity C2 of channels of the audio signal included in the second reconstructed scene audio signal may be greater than or equal to a quantity C1 of channels of the audio signal included in the scene audio signal.

For example, when the order quantity N2 of the second reconstructed scene audio signal is equal to the order quantity N1 of the scene audio signal, the decoder side may reconstruct a reconstructed scene audio signal whose order quantity is the same as an order quantity of the scene audio signal encoded by the encoder side.

For example, when the order quantity N2 of the second reconstructed scene audio signal is greater than the order quantity N1 of the scene audio signal, the decoder side may reconstruct a reconstructed scene audio signal whose order quantity is greater than an order quantity of the scene audio signal encoded by the encoder side.

Any one of the second aspect and the implementations of the second aspect corresponds to any one of the first aspect and the implementations of the first aspect. For technical effects corresponding to any one of the second aspect and the implementations of the second aspect, refer to technical effects corresponding to any one of the first aspect and the implementations of the first aspect. Details are not described herein again.

According to a third aspect, an embodiment provides a bitstream generation method. The method may generate a bitstream according to any one of the first aspect or the implementations of the first aspect.

Any one of the third aspect and the implementations of the third aspect corresponds to any one of the first aspect and the implementations of the first aspect. For technical effects corresponding to any one of the third aspect and the implementations of the third aspect, refer to technical effects corresponding to any one of the first aspect and the implementations of the first aspect. Details are not described herein again.

According to a fourth aspect, an embodiment provides a scene audio encoding apparatus. The apparatus includes: a signal obtaining module, configured to obtain a to-be-encoded scene audio signal, where the scene audio signal includes an audio signal with C1 channels, and C1 is a positive integer; an attribute information obtaining module, configured to determine attribute information of a target virtual speaker based on the scene audio signal; and an encoding module, configured to encode a first audio signal in the scene audio signal and the attribute information of the target virtual speaker, to obtain a first bitstream, where the first audio signal is an audio signal with K channels in the scene audio signal, and K is a positive integer less than or equal to C1.

The scene audio encoding apparatus in the fourth aspect may perform the steps in any one of the first aspect and the implementations of the first aspect. Details are not described herein again.

Any one of the fourth aspect and the implementations of the fourth aspect corresponds to any one of the first aspect and the implementations of the first aspect. For technical effects corresponding to any one of the fourth aspect and the implementations of the fourth aspect, refer to technical effects corresponding to any one of the first aspect and the implementations of the first aspect. Details are not described herein again.

According to a fifth aspect, an embodiment provides a scene audio decoding apparatus. The apparatus includes: a bitstream receiving module, configured to receive a first bitstream; a decoding module, configured to decode the first bitstream, to obtain a first reconstructed signal and attribute information of a target virtual speaker, where the first reconstructed signal is a reconstructed signal of a first audio signal in a scene audio signal, the scene audio signal includes an audio signal with C1 channels, the first audio signal is an audio signal with K channels in the scene audio signal, C1 is a positive integer, and K is a positive integer less than or equal to C1; a virtual speaker signal generation module, configured to generate, based on the attribute information and the first reconstructed signal, a virtual speaker signal corresponding to the target virtual speaker; and a scene audio signal reconstruction module, configured to perform reconstruction based on the attribute information and the virtual speaker signal, to obtain a first reconstructed scene audio signal, where the first reconstructed scene audio signal includes an audio signal with C2 channels, and C2 is a positive integer.

The scene audio decoding apparatus in the fifth aspect may perform the steps in any one of the second aspect and the implementations of the second aspect. Details are not described herein again.

Any one of the fifth aspect and the implementations of the fifth aspect corresponds to any one of the second aspect and the implementations of the second aspect. For technical effects corresponding to any one of the fifth aspect and the implementations of the fifth aspect, refer to technical effects corresponding to any one of the second aspect and the implementations of the second aspect. Details are not described herein again.

According to a sixth aspect, an embodiment provides an electronic device, including a memory and a processor. The memory is coupled to the processor, the memory stores program instructions, and when the program instructions are executed by the processor, the electronic device is enabled to perform the scene audio encoding method according to any one of the first aspect or the possible implementations of the first aspect.

Any one of the sixth aspect and the implementations of the sixth aspect corresponds to any one of the first aspect and the implementations of the first aspect. For technical effects corresponding to any one of the sixth aspect and the implementations of the sixth aspect, refer to technical effects corresponding to any one of the first aspect and the implementations of the first aspect. Details are not described herein again.

According to a seventh aspect, an embodiment provides an electronic device, including a memory and a processor. The memory is coupled to the processor, the memory stores program instructions, and when the program instructions are executed by the processor, the electronic device is enabled to perform the scene audio decoding method according to any one of the second aspect or the possible implementations of the second aspect.

Any one of the seventh aspect and the implementations of the seventh aspect corresponds to any one of the second aspect and the implementations of the second aspect. For technical effect corresponding to any one of the seventh aspect and the implementations of the seventh aspect, refer to the technical effect corresponding to any one of the second aspect and the implementations of the second aspect. Details are not described herein again.

According to an eighth aspect, an embodiment provides a chip, including one or more interface circuits and one or more processors. The interface circuit is configured to: receive a signal from a memory of an electronic device, and send the signal to the processor. The signal includes computer instructions stored in the memory. When the processor executes the computer instructions, the electronic device is enabled to perform the scene audio encoding method according to any one of the first aspect or the possible implementations of the first aspect.

Any one of the eighth aspect and the implementations of the eighth aspect corresponds to any one of the first aspect and the implementations of the first aspect. For technical effects corresponding to any one of the eighth aspect and the implementations of the eighth aspect, refer to technical effects corresponding to any one of the first aspect and the implementations of the first aspect. Details are not described herein again.

According to a ninth aspect, an embodiment provides a chip, including one or more interface circuits and one or more processors. The interface circuit is configured to: receive a signal from a memory of an electronic device, and send the signal to the processor. The signal includes computer instructions stored in the memory. When the processor executes the computer instructions, the electronic device is enabled to perform the scene audio decoding method according to any one of the second aspect or the possible implementations of the second aspect.

Any one of the ninth aspect and the implementations of the ninth aspect corresponds to any one of the second aspect and the implementations of the second aspect. For technical effect corresponding to any one of the ninth aspect and the implementations of the ninth aspect, refer to the technical effect corresponding to any one of the second aspect and the implementations of the second aspect. Details are not described herein again.

According to a tenth aspect, an embodiment provides a computer-readable storage medium. The computer-readable storage medium stores a computer program. When the computer program is run on a computer or a processor, the computer or the processor is enabled to perform the scene audio encoding method according to any one of the first aspect or the possible implementations of the first aspect.

Any one of the tenth aspect and the implementations of the tenth aspect corresponds to any one of the first aspect and the implementations of the first aspect. For technical effects corresponding to any one of the tenth aspect and the implementations of the tenth aspect, refer to technical effects corresponding to any one of the first aspect and the implementations of the first aspect. Details are not described herein again.

According to an eleventh aspect, an embodiment provides a computer-readable storage medium. The computer-readable storage medium stores a computer program. When the computer program is run on a computer or a processor, the computer or the processor is enabled to perform the scene audio decoding method according to any one of the second aspect or the possible implementations of the second aspect.

Any one of the eleventh aspect and the implementations of the eleventh aspect corresponds to any one of the second aspect and the implementations of the second aspect. For technical effects corresponding to any one of the eleventh aspect and the implementations of the eleventh aspect, refer to technical effects corresponding to any one of the second aspect and the implementations of the second aspect. Details are not described herein again.

According to a twelfth aspect, an embodiment provides a computer program product. The computer program product includes a software program. When the software program is executed by a computer or a processor, the computer or the processor is enabled to perform the scene audio encoding method according to any one of the first aspect or the possible implementations of the first aspect.

Any one of the twelfth aspect and the implementations of the twelfth aspect corresponds to any one of the first aspect and the implementations of the first aspect. For technical effect corresponding to any one of the twelfth aspect and the implementations of the twelfth aspect, refer to the technical effect corresponding to any one of the first aspect and the implementations of the first aspect. Details are not described herein again.

According to a thirteenth aspect, an embodiment provides a computer program product. The computer program product includes a software program. When the software program is executed by a computer or a processor, the computer or the processor is enabled to perform the scene audio decoding method according to any one of the second aspect or the possible implementations of the second aspect.

Any one of the thirteenth aspect and the implementations of the thirteenth aspect corresponds to any one of the second aspect and the implementations of the second aspect. For technical effect corresponding to any one of the thirteenth aspect and the implementations of the thirteenth aspect, refer to the technical effect corresponding to any one of the second aspect and the implementations of the second aspect. Details are not described herein again.

According to a fourteenth aspect, an embodiment provides a bitstream storage apparatus. The apparatus includes a receiver and at least one storage medium. The receiver is configured to receive a bitstream. The at least one storage medium is configured to store the bitstream. The bitstream is generated according to any one of the first aspect and the implementations of the first aspect.

Any one of the fourteenth aspect and the implementations of the fourteenth aspect corresponds to any one of the first aspect and the implementations of the first aspect. For technical effects corresponding to any one of the fourteenth aspect and the implementations of the fourteenth aspect, refer to the technical effects corresponding to any one of the first aspect and the implementations of the first aspect. Details are not described herein again.

According to a fifteenth aspect, an embodiment provides a bitstream transmission apparatus. The apparatus includes a transmitter and at least one storage medium. The at least one storage medium is configured to store a bitstream. The bitstream is generated according to the first aspect and any one of the implementations of the first aspect. The transmitter is configured to: obtain the bitstream from the storage medium, and send the bitstream to a terminal-side device through a transmission medium.

Any one of the fifteenth aspect and the implementations of the fifteenth aspect corresponds to any one of the first aspect and the implementations of the first aspect. For technical effect corresponding to any one of the fifteenth aspect and the implementations of the fifteenth aspect, refer to the technical effect corresponding to any one of the first aspect and the implementations of the first aspect. Details are not described herein again.

According to sixteenth aspect, an embodiment provides a bitstream distribution system. The system includes: at least one storage medium, configured to store at least one bitstream, where the at least one bitstream is generated according to any one of the first aspect and the implementations of the first aspect; and a streaming media device, configured to: obtain a target bitstream from the at least one storage medium, and send the target bitstream to a terminal-side device. The streaming media device includes a content server or a content delivery server.

Any one of the sixteenth aspect and the implementations of the sixteenth aspect corresponds to any one of the first aspect and the implementations of the first aspect. For technical effects corresponding to any one of the sixteenth aspect and the implementations of the sixteenth aspect, refer to technical effects corresponding to any one of the first aspect and the implementations of the first aspect. Details are not described herein again.

### BRIEF DESCRIPTION OF DRAWINGS

FIG. 1A is a diagram of an example application scenario;

FIG. 1B is a diagram of an example application scenario;

FIG. 2A is a diagram of an example encoding process;

FIG. 2B is a diagram of an example distribution of candidate virtual speakers;

FIG. 3 is a diagram of an example decoding process;

FIG. 4 is a diagram of an example encoding process;

FIG. 5 is a diagram of an example decoding process;

FIG. 6A is a diagram of an example structure of an encoder side;

FIG. 6B is a diagram of an example structure of a decoder side;

FIG. 7 is a diagram of an example encoding process;

FIG. 8 is a diagram of an example decoding process;

FIG. 9A is a diagram of an example structure of an encoder side;

FIG. 9B is a diagram of an example structure of a decoder side;

FIG. 10 is a diagram of an example structure of a scene audio encoding apparatus;

FIG. 11 is a diagram of an example structure of a scene audio decoding apparatus; and

FIG. 12 is a diagram of an example structure of an apparatus.

### DESCRIPTION OF EMBODIMENTS

The following clearly and completely describes the technical solutions in embodiments of this disclosure with reference to the accompanying drawings in embodiments. It is clear that the described embodiments are some but not all of embodiments of this disclosure. All other embodiments obtained by a person of ordinary skill in the art based on embodiments of this disclosure without creative efforts shall fall within the protection scope of this disclosure.

The term “and/or” in this specification describes only an association relationship for describing associated objects and represents that three relationships may exist. For example, A and/or B may represent the following three cases: Only A exists, both A and B exist, and only B exists.

In the specification and claims of embodiments of this disclosure, the terms such as “first” and “second” are intended to distinguish between different objects but do not indicate a particular order of the objects. For example, a first target object, a second target object, and the like are used to distinguish between different target objects, but do not indicate a particular order of the objects.

In embodiments, the word such as “example” or “for example” is used to represent giving an example, an illustration, or a description. Any embodiment or design solution described as an “example” or “for example” in embodiments should not be explained as being more preferred or having more advantages than another embodiment or design solution. To be precise, use of the word such as “example” or “for example” is intended to present a relative concept in a specific manner.

In descriptions of embodiments, unless otherwise specified, “a plurality of” means two or more. For example, a plurality of processing units are two or more processing units, and a plurality of systems are two or more systems.

For clear and brief description of the following embodiments, a brief description of a related technology is first provided.

A sound is a continuous wave generated by an object through vibration. An object that vibrates to emit a sound wave is referred to as a sound source. In a process in which the sound wave is propagated through a medium (for example, air, solid, or liquid), an auditory organ of a human or an animal can sense the sound.

Features of the sound wave include a tone, intensity, and a timbre. The tone indicates a level of the sound. The intensity indicates volume of the sound. The intensity may also be referred to as loudness or volume. A unit of the intensity is decibel (dB). The timbre is also referred to as sound quality.

A frequency of the sound wave determines the level of the tone. A higher frequency indicates a higher tone. A quantity of times that the object vibrates in 1 second is referred to as a frequency, and a frequency unit is Hertz (Hz). A frequency of a sound that can be recognized by a human ear is between 20 Hz and 20000 Hz.

An amplitude of the sound wave determines the intensity. A larger amplitude indicates higher intensity. A shorter distance from the sound source indicates higher intensity.

A waveform of the sound wave determines the timbre. Waveforms of sound waves include a square wave, a sawtooth wave, a sine wave, a pulse wave, and the like.

Sounds may be classified into a regular sound and an irregular sound based on features of sound waves. The irregular sound is a sound emitted by a sound source that vibrates irregularly. The irregular sound is, for example, noise that affects people's work, study, rest, and the like. The regular sound is a sound emitted by a sound source that vibrates regularly. Regular sounds include a voice and a music sound. When a sound is represented electrically, the regular sound is an analog signal that changes continuously in time-frequency domain. The analog signal may be referred to as an audio signal. The audio signal is an information carrier that carries a voice, music, and sound effects.

Because human's auditory sense has a capability of distinguishing location distribution of a sound source in space, when hearing a sound in space, a listener can sense a direction and a location of the sound in addition to a tone, intensity, and a timbre of the sound.

As attention to and quality requirements for experience of an auditory system increase, a three-dimensional audio technology emerges, to enhance a sense of depth, a sense of presence, and a sense of space of a sound. Therefore, the listener not only senses sounds from front, back, left, and right sound sources, but also senses a feeling that space in which the listener is located is enveloped by spatial sound fields (briefly referred to as “sound field”) generated by these sound sources, and a feeling that the sounds diffuse around, to create an “immersive” sound effect exerted when the listener is located in a place such as a theater or a concert hall.

A scene audio signal in embodiments may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal. The following provides descriptions by using the HOA signal as an example.

It is well known that the sound wave is propagated in an ideal medium, a quantity of waves is k=w/c, and an angular frequency is w=2πf Herein, f is a sound wave frequency, and c is a sound speed. Sound pressure p satisfies Formula (1). Herein, ∇² is a Laplacian operator.

$${∇}^{2} p + {k}^{2} p = 0 \qquad ( 1 )$$

It is assumed that a spatial system outside the human ear is a sphere, and the listener is at a center of the sphere. A sound transmitted from an outside of the sphere has a projection on a spherical surface, and a sound outside the spherical surface is filtered out. It is assumed that a sound source is distributed on the spherical surface, and a sound field generated by the sound source on the spherical surface fits a sound field generated by an original sound source. That is, the three-dimensional audio technology is a sound field fitting method. An equation, namely, Formula (1) is solved in a spherical coordinate system. In a passive spherical area, a solution to the equation, namely, Formula (1) is Formula (2).

$$p ( r , θ , φ , k ) = s {\sum }_{m}^{∞} ( 2 m + 1 ) {j}^{m} {j}_{m}^{k r} ( k r ) {\sum }_{0 < n < m , σ = \pm 1} {Y}_{m , n}^{σ} ( {θ}_{s} , {φ}_{s} ) {Y}_{m , n}^{σ} ( θ , φ ) \qquad ( 2 )$$

Herein, r represents a sphere radius, θ represents horizontal angle information (or referred to as azimuth information), φ represents pitch angle information (or referred to as elevation angle information), k represents the quantity of waves, S represents an amplitude of an ideal plane wave, and m represents a sequence number of an order quantity of the HOA signal (or referred to as the sequence number of the order quantity of the HOA signal). j^{m} jₘ^{kr} (kr) represents a sphere Bessel function, and the sphere Bessel function is also referred to as a radial basis function. First “j” represents an imaginary unit, and (2m+1) j^{m} jₘ^{kr} (kr) does not change with an angle. Y_{m,n}^{σ} (θ, φ) represents a spherical harmonic function in directions of θ and φ, and Y_{m,n}^{σ} (θₛ, φₛ) represents a spherical harmonic function in a direction of the sound source. The HOA signal satisfies Formula (3).

$${B}_{m , n}^{σ} = s \cdot {Y}_{m , n}^{σ} ( {θ}_{s} , {φ}_{s} ) \qquad ( 3 )$$

Formula (3) is substituted into Formula (2), and Formula (2) may be deformed into Formula (4).

$$p ( r , θ , φ , k ) = {\sum }_{m = 0}^{∞} {j}^{m} {j}_{m}^{k r} ( k r ) {\sum }_{0 < n < m , σ = \pm 1} {B}_{m , n}^{σ} {Y}_{m , n}^{σ} ( θ , φ ) \qquad ( 4 )$$

Herein, m is truncated to an N^{th} item, that is, m=N, and B_{m,n}^{σ} is used as an approximate description of the sound field. In this case, B_{m,n}^{σ} may be referred to as an HOA coefficient (which may be used to represent an N-order HOA signal). The sound field is an area in which a sound wave exists in a medium. N is an integer greater than or equal to 1.

The scene audio signal is an information carrier that carries spatial location information of a sound source in a sound field, and describes a sound field of a listener in space. Formula (4) indicates that the sound field may be expanded on the spherical surface based on a spherical harmonic function. In other words, the sound field may be decomposed into superimposition of a plurality of plane waves. Therefore, the sound field described by the HOA signal may be expressed through superimposition of a plurality of plane waves, and the sound field is reconstructed based on the HOA coefficient.

A to-be-encoded HOA signal in embodiments may be an N1-order HOA signal, and may be represented by using an HOA coefficient or an Ambisonic coefficient. N1 is an integer greater than or equal to 1 (when N1 is equal to 1, a one-order HOA signal may be referred to as an FOA (First Order Ambisonic) signal. The N1-order HOA signal includes an audio signal with (N1+1)² channels.

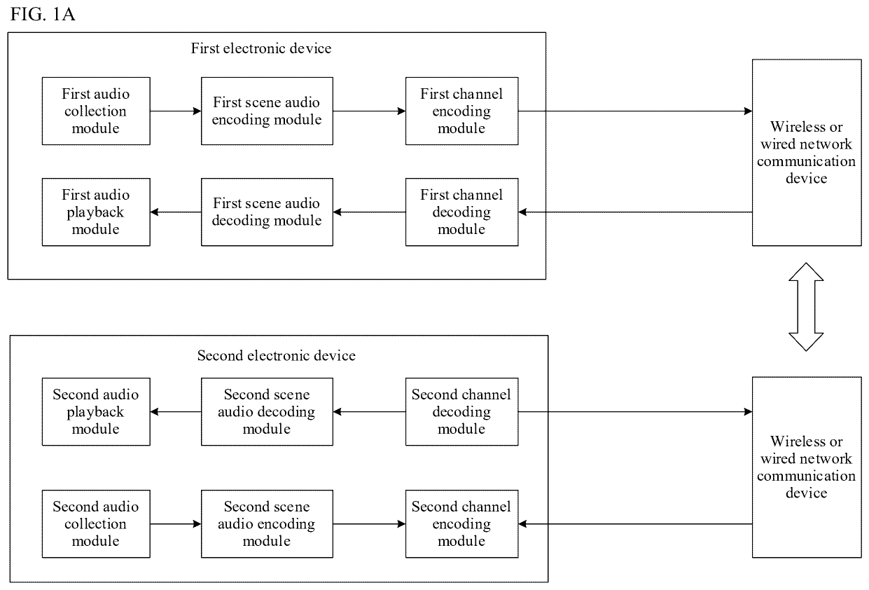

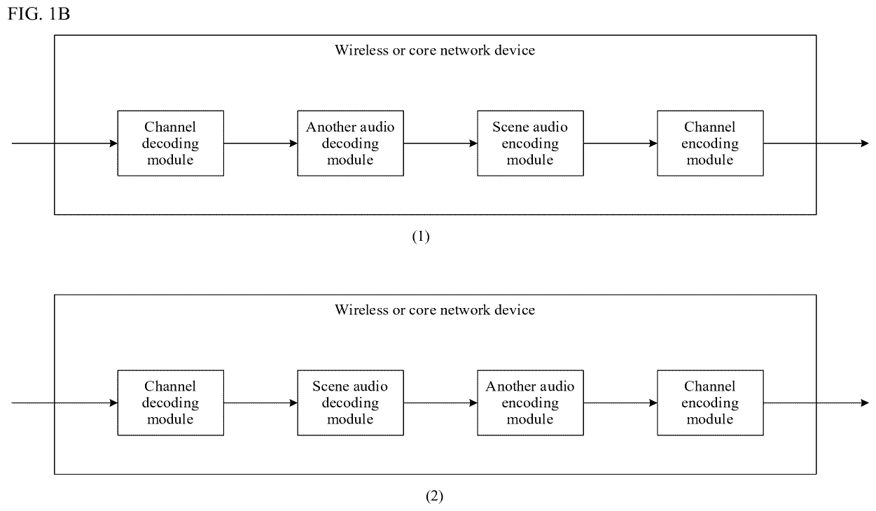

FIG. 1A is a diagram of an example application scenario. FIG. 1A shows a scenario of encoding and decoding a scene audio signal.

As shown in FIG. 1A, for example, a first electronic device may include a first audio collection module, a first scene audio encoding module, a first channel encoding module, a first channel decoding module, a first scene audio decoding module, and a first audio playback module. It should be understood that the first electronic device may include more or fewer modules than those shown in FIG. 1A. This is not limited in this disclosure.

As shown in FIG. 1A, for example, the second electronic device may include a second audio collection module, a second scene audio encoding module, a second channel encoding module, a second channel decoding module, a second scene audio decoding module, and a second audio playback module. It should be understood that the second electronic device may include more or fewer modules than those shown in FIG. 1A. This is not limited in this disclosure.

For example, a process in which the first electronic device encodes and transmits the scene audio signal to the second electronic device, and the second electronic device performs decoding and audio playback may be as follows: The first audio collection module may collect the audio, and output the scene audio signal to the first scene audio encoding module. Then, the first scene audio encoding module may encode the scene audio signal, and output a bitstream to the first channel encoding module. Then, the first channel encoding module may perform channel encoding on the bitstream, and transmit, to the second electronic device through a wireless or wired network communication device, the bitstream on which channel encoding is performed. Then, the second channel decoding module of the second electronic device may perform channel decoding on received data, to obtain a bitstream and output the bitstream to the second scene audio decoding module. Then, the second scene audio decoding module may decode the bitstream, to obtain a reconstructed scene audio signal; and then output the reconstructed scene audio signal to the second audio playback module, and the second audio playback module performs audio playback.

It should be noted that the second audio playback module may perform post-processing (for example, audio rendering (for example, converting a reconstructed scene audio signal including an audio signal with (N1+1)² channels into an audio signal with a same quantity of channels as a quantity of speakers in the second electronic device), loudness normalization, user interaction, audio format conversion, or denoising) on the reconstructed scene audio signal, to convert the reconstructed scene audio signal into an audio signal suitable for playing by the speaker in the second electronic device.

It should be understood that a process in which the second electronic device encodes and transmits a scene audio signal to the first electronic device, and the first electronic device performs decoding and audio playback is similar to the foregoing process in which the first electronic device transmits the scene audio signal to the second electronic device, and the second electronic device performs audio playback. Details are not described herein again.

For example, the first electronic device and the second electronic device each may include but are not limited to a personal computer, a computer workstation, a smartphone, a tablet computer, a server, a smart camera, an intelligent vehicle, another type of cellular phone, a media consumption device, a wearable device, a set-top box, a game console, and the like.

For example, this disclosure may be applied to a Virtual Reality/Augmented Reality (VR/AR) scenario. In a possible manner, the first electronic device is a server, and the second electronic device is a VR/AR device. In a possible manner, the second electronic device is a server, and the first electronic device is a VR/AR device.

For example, the first scene audio encoding module and the second scene audio encoding module may be scene audio encoders. The first scene audio decoding module and the second scene audio decoding module may be scene audio decoders.

For example, when the first electronic device encodes the scene audio signal, and the second electronic device reconstructs the scene audio signal, the first electronic device may be referred to as an encoder side, and the second electronic device may be referred to as a decoder side. When the second electronic device encodes the scene audio signal, and the first electronic device reconstructs the scene audio signal, the second electronic device may be referred to as an encoder side, and the first electronic device may be referred to as a decoder side.

FIG. 1B is a diagram of an example application scenario. FIG. 1B shows a transcoding scenario of a scene audio signal.

As shown in (1) in FIG. 1B, for example, a wireless or core network device may include a channel decoding module, another audio decoding module, a scene audio encoding module, and a channel encoding module. The wireless or core network device may be configured to perform audio transcoding.

For example, an example application scenario in (1) in FIG. 1B may be as follows: A first electronic device is not provided with a scene audio encoding module, and is provided with only another audio encoding module. A second electronic device is provided with only a scene audio decoding module, and is not provided with another audio decoding module. The wireless or core network device may be used for transcoding, so that the second electronic device can decode and play back a scene audio signal encoded by the first electronic device by using the another audio encoding module.

The first electronic device encodes the scene audio signal by using the another audio encoding module, to obtain a first bitstream; and performs channel encoding on the first bitstream and sends the first bitstream to the wireless or core network device. Then, the channel decoding module of the wireless or core network device may perform channel decoding, and output, to the another audio decoding module, the first bitstream obtained through channel decoding. Then, the another audio decoding module decodes the first bitstream, to obtain the scene audio signal, and outputs the scene audio signal to the scene audio encoding module. Then, the scene audio encoding module may encode the scene audio signal, to obtain a second bitstream, and output the second bitstream to the channel encoding module. After performing channel encoding on the second bitstream, the channel encoding module sends the second bitstream to the second electronic device. In this way, the second electronic device may invoke the scene audio decoding module to decode the second bitstream obtained through channel decoding, to obtain a reconstructed scene audio signal; and subsequently, may perform audio playback on the reconstructed scene audio signal.

As shown in (2) in FIG. 1B, for example, a wireless or core network device may include a channel decoding module, a scene audio decoding module, another audio encoding module, and a channel encoding module. The wireless or core network device may be configured to perform audio transcoding.

For example, an example application scenario in (2) in FIG. 1B may be as follows: A first electronic device is provided with only a scene audio encoding module, and is not provided with another audio encoding module. A second electronic device is not provided with a scene audio decoding module, and is only provided with another audio decoding module. The wireless or core network device may be used for transcoding, so that the second electronic device can decode and play back a scene audio signal encoded by the first electronic device by using the scene audio encoding module.

The first electronic device encodes the scene audio signal by using the scene audio encoding module, to obtain a first bitstream; and performs channel encoding on the first bitstream and sends the first bitstream to the wireless or core network device. Then, the channel decoding module of the wireless or core network device may perform channel decoding, and output, to the scene audio decoding module, the first bitstream obtained through channel decoding. Then, the scene audio decoding module decodes the first bitstream, to obtain the scene audio signal, and outputs the scene audio signal to the another audio encoding module. Then, the another audio encoding module may encode the scene audio signal, to obtain a second bitstream, and output the second bitstream to the channel encoding module. After performing channel encoding on the second bitstream, the channel encoding module sends the second bitstream to the second electronic device. In this way, the second electronic device may invoke the another audio decoding module to decode the second bitstream obtained through channel decoding, to obtain a reconstructed scene audio signal; and subsequently, may perform audio playback on the reconstructed scene audio signal.

The following describes a process of encoding and decoding a scene audio signal.

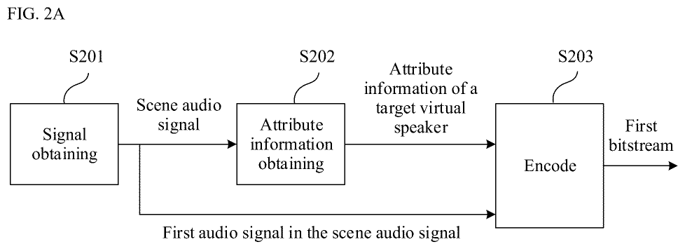

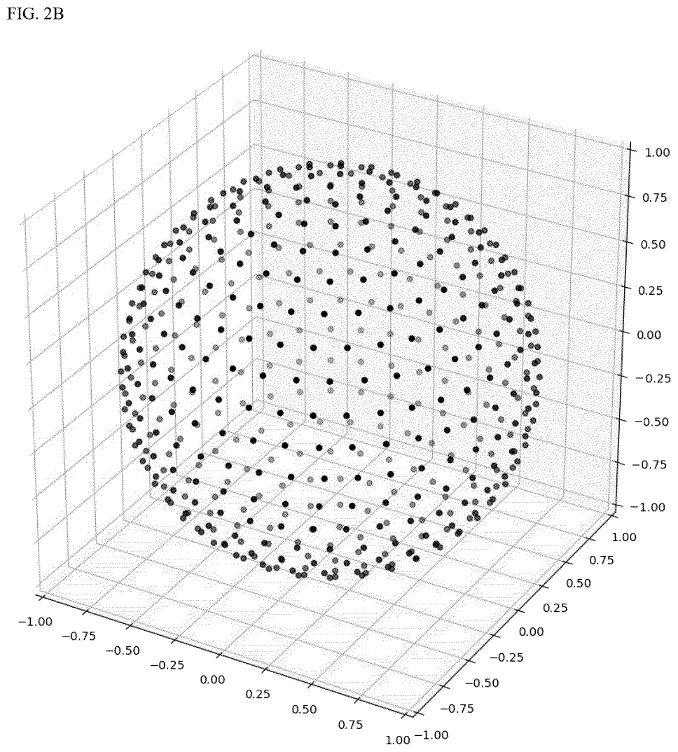

FIG. 2A is a diagram of an example encoding process.
S201: Obtain a to-be-encoded scene audio signal, where the scene audio signal includes an audio signal with C1 channels, and C1 is a positive integer.

For example, when the scene audio signal is an HOA signal, the HOA signal may be an N1-order HOA signal, that is, B_{m,n}^{σ} in Formula (3) when m is truncated to an (N1)^{th} item.

For example, the N1-order HOA signal may include an audio signal with C1 channels. C1=(N1+1)². For example, when N1=3, the N1-order HOA signal includes an audio signal with 16 channels; and when N1=4, the N1-order HOA signal includes an audio signal with 25 channels.
S202: Determine attribute information of a target virtual speaker based on the scene audio signal.
S203: Encode a first audio signal in the scene audio signal and the attribute information of the target virtual speaker, to obtain a first bitstream, where the first audio signal is an audio signal with K channels in the scene audio signal, and K is a positive integer less than or equal to C1.

For example, a virtual speaker is a speaker that is virtual, and is not a speaker that actually exists.

For example, it can be learned, based on the foregoing descriptions, that the scene audio signal may be expressed through superimposition of a plurality of plane waves, and further, a target virtual speaker used to simulate a sound source in the scene audio signal may be determined. In this way, in a subsequent decoding process, a virtual speaker signal corresponding to the target virtual speaker is used to reconstruct the scene audio signal.

In a possible manner, a plurality of candidate virtual speakers at different locations may be disposed on a spherical surface; and then, a target virtual speaker whose location matches a location of the sound source in the scene audio signal may be selected from the plurality of candidate virtual speakers.

FIG. 2B is a diagram of an example distribution of candidate virtual speakers. In FIG. 2B, the plurality of candidate virtual speakers may be evenly distributed on the spherical surface, and one point on the spherical surface represents one candidate virtual speaker.

It should be noted that a quantity of candidate virtual speakers and a distribution of the candidate virtual speakers are not limited in this disclosure, and may be set according to a requirement. Details are described subsequently.

For example, the target virtual speaker whose location matches the location of the sound source in the scene audio signal may be selected from the plurality of candidate virtual speakers based on the scene audio signal. There may be one or more target virtual speakers. This is not limited in this disclosure.

In a possible manner, the target virtual speaker may be preset.

It should be understood that a manner of determining the target virtual speaker is not limited in this disclosure.

For example, in a possible manner, in the decoding process, the scene audio signal may be reconstructed based on the virtual speaker signal. However, a bit rate is increased when the virtual speaker signal of the target virtual speaker is directly transmitted. The virtual speaker signal of the target virtual speaker may be generated based on the attribute information of the target virtual speaker and a scene audio signal with some or all channels. Therefore, the attribute information of the target virtual speaker may be obtained, and the audio signal with the K channels in the scene audio signal may be obtained as the first audio signal. Then, the first audio signal and the attribute information of the target virtual speaker are encoded, to obtain the first bitstream.

For example, operations such as downmixing, transformation, quantization, and entropy encoding may be performed on the first audio signal and the attribute information of the target virtual speaker, to obtain the first bitstream. In other words, the first bitstream may include encoded data of the first audio signal in the scene audio signal and encoded data of the attribute information of the target virtual speaker.

Compared with that in another scene audio signal reconstruction method in some technologies, audio quality of the scene audio signal reconstructed based on the virtual speaker signal is higher. Therefore, when K is equal to C1, the audio quality of the scene audio signal reconstructed disclosure is higher at a same bit rate.

When K is less than C1, in a process of encoding the scene audio signal, a quantity of channels of an encoded audio signal disclosure is less than a quantity of channels of an encoded audio signal in some technologies, and a data amount of the attribute information of the target virtual speaker is far less than a data amount of an audio signal with one channel. Therefore, an encoding bit rate disclosure is lower while same quality is achieved.

In addition, in some technologies, the scene audio signal is converted into a virtual speaker signal and a residual signal and then encoded. disclosure, an encoder side directly encodes an audio signal with some channels in the scene audio signal, without a need to calculate the virtual speaker signal and the residual signal. In this way, encoding complexity of the encoder side is lower.

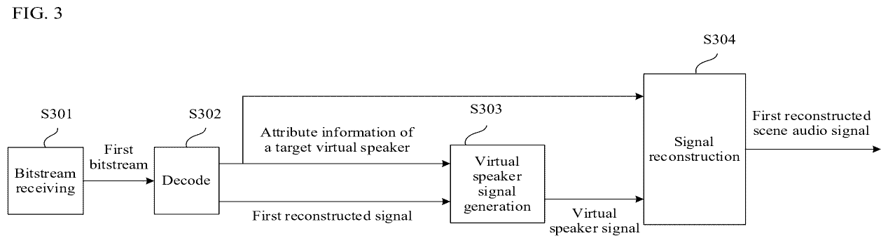

FIG. 3 is a diagram of an example decoding process. FIG. 3 shows a decoding process corresponding to the encoding process in FIG. 2.
S301: Receive a first bitstream.
S302: Decode the first bitstream, to obtain a first reconstructed signal and attribute information of a target virtual speaker.

For example, encoded data of a first audio signal in a scene audio signal included in the first bitstream may be decoded, to obtain the first reconstructed signal. That is, the first reconstructed signal is a reconstructed signal of the first audio signal. In addition, encoded data of the attribute information of the target virtual speaker included in the first bitstream may be decoded, to obtain the attribute information of the target virtual speaker.

It should be understood that, when an encoder side performs lossy compression on the first audio signal in the scene audio signal, there is a difference between a first reconstructed signal obtained by a decoder side through decoding and the first audio signal encoded by the encoder side. When the encoder side performs lossless compression on the first audio signal, a first reconstructed signal obtained by the decoder side through decoding is the same as the first audio signal encoded by the encoder side.

It should be understood that, when the encoder side performs lossy compression on the attribute information of the target virtual speaker, there is a difference between attribute information obtained by the decoder side through decoding and the attribute information encoded by the encoder side. When the encoder side performs lossless compression on the attribute information of the virtual speaker, attribute information obtained by the decoder side through decoding is the same as the attribute information encoded by the encoder side. (In this disclosure, the attribute information encoded by the encoder side and the attribute information obtained by the decoder side through decoding are not distinguished by name.)
S303: Generate, based on the attribute information and the first reconstructed signal, a virtual speaker signal corresponding to the target virtual speaker.
S304: Perform reconstruction based on the attribute information and the virtual speaker signal, to obtain a first reconstructed scene audio signal.

For example, it can be learned, based on the foregoing descriptions, that the scene audio signal may be reconstructed based on the virtual speaker signal, and further, the virtual speaker signal corresponding to the target virtual speaker may be first generated based on the attribute information of the target virtual speaker and the first reconstructed signal. One target virtual speaker corresponds to one virtual speaker signal, and the virtual speaker signal is a plane wave. Then, reconstruction is performed based on the attribute information of the target virtual speaker and the virtual speaker signal, to generate the first reconstructed scene audio signal.

For example, when the scene audio signal is an HOA signal, the reconstructed first reconstructed scene audio signal may also be an HOA signal. The HOA signal may be an N2-order HOA signal, and N2 is a positive integer. For example, the N2-order HOA signal may include an audio signal with C2 channels. C2=(N2+1)².

For example, an order quantity N2 of the first reconstructed scene audio signal may be greater than or equal to an order quantity N1 of the scene audio signal in the embodiment in FIG. 2A. Correspondingly, a quantity C2 of channels of an audio signal included in the first reconstructed scene audio signal may be greater than or equal to a quantity C1 of channels of an audio signal included in the scene audio signal in the embodiment in FIG. 2A.

In a possible manner, the first reconstructed scene audio signal may be directly used as a final decoding result.

Compared with that in another scene audio signal reconstruction method in some technologies, audio quality of the scene audio signal reconstructed based on a virtual speaker signal is higher. Therefore, when K is equal to C1, the audio quality of the scene audio signal reconstructed disclosure is higher at a same bit rate.

When K is less than C1, in a process of encoding the scene audio signal, a quantity of channels of an encoded audio signal disclosure is less than a quantity of channels of an encoded audio signal in some technologies, and a data amount of the attribute information of the target virtual speaker is far less than a data amount of an audio signal with one channel. Therefore, audio quality of the reconstructed scene audio signal obtained through decoding disclosure is higher at a same bit rate.

Because a virtual speaker signal and residual information that are encoded and transmitted in some technologies are converted from an original audio signal (namely, a to-be-encoded scene audio signal) and are not an original audio signal, an error is introduced. However, in this disclosure, some original audio signals (namely, an audio signal with K channels in the to-be-encoded scene audio signal) are encoded, to avoid introducing an error and improve audio quality of the reconstructed scene audio signal obtained through decoding. In addition, a fluctuation of reconstruction quality of the reconstructed scene audio signal obtained through decoding can be avoided, and stability is high.

In addition, because the virtual speaker signal is encoded and transmitted in some technologies, and a data amount of the virtual speaker signal is large, a quantity of target virtual speakers selected in some technologies is greatly limited by a bandwidth. disclosure, attribute information of a virtual speaker is encoded and transmitted, and a data amount of the attribute information is far less than the data amount of a virtual speaker signal. Therefore, a quantity of target virtual speakers selected disclosure is less limited by a bandwidth. A larger quantity of selected target virtual speakers indicates higher quality of a scene audio signal reconstructed based on a virtual speaker signal of the target virtual speaker. Therefore, compared with some technologies, disclosure, more target virtual speakers may be selected at a same bit rate. In this way, quality of the reconstructed scene audio signal obtained through decoding disclosure is higher.

In addition, both an encoder side and a decoder side are considered. Compared with an encoder side and a decoder side in some technologies, an encoder side and a decoder side disclosure do not need to perform residual and superimposition operations. Therefore, comprehensive complexity of the encoder side and the decoder side disclosure is lower than comprehensive complexity of the encoder side and the decoder side in some technologies.

The following provides descriptions by using an example in which the scene audio signal is an N1-order HOA signal, the first reconstructed scene audio signal is an N2-order HOA signal, both N1 and N2 are greater than 1, and K is less than C1.

In a possible manner, a second reconstructed scene audio signal may be generated based on the first reconstructed scene audio signal and the first reconstructed signal, and then the second reconstructed scene audio signal is used as a final decoding result. An audio signal corresponding to a channel in the first reconstructed scene audio signal and an audio signal corresponding to a channel in the first audio signal may be replaced with the first reconstructed signal. The first reconstructed signal obtained through decoding is closer to the encoded first audio signal than the audio signal corresponding to the channel in the first reconstructed scene audio signal and the audio signal corresponding to the channel in the first audio signal. Therefore, audio quality of the obtained second reconstructed scene audio signal is higher than audio quality of the first reconstructed scene audio signal.

To facilitate subsequent descriptions of a process of generating the second reconstructed scene audio signal, components of the scene audio signal (namely, the N1-order HOA signal) and the first reconstructed scene audio signal (namely, the N2-order HOA signal) are first described.

For example, the N1-order HOA signal may include a second audio signal and a third audio signal, and the second audio signal is an HOA signal obtained when the N1-order HOA signal is truncated to an M-order HOA signal (in other words, the second audio signal is a 0th-order signal to an Mth-order signal in the N1-order HOA signal, the second audio signal includes an audio signal with (M+1)² channels, and M is an integer less than N1). The third audio signal is an audio signal in the N1-order HOA signal other than the second audio signal.

In a possible manner, the second audio signal may be referred to as a low-order part of the N1-order HOA signal, and the third audio signal may be referred to as a high-order part of the N1-order HOA signal.

For example, if N1=3, the N1-order HOA signal may include an audio signal with 16 channels.

For example, it can be learned, with reference to Formula (3), that when N1 is equal to 3 (that is, m in Formula (3) is equal to 3), 16 monomials may be obtained by expanding Formula (3). Each monomial may represent an audio signal with one channel in the N1-order HOA signal.

When a value of n in Formula (3) is 0, one monomial may be obtained by expanding Formula (3), as shown in Formula (5). In this case, an audio signal with one channel may be obtained. When the value of n in Formula (3) is 1, three monomials may be obtained by expanding Formula (3), as shown in Formula (6). In this case, an audio signal with three channels may be obtained. When a value of n in Formula (4) is 2, five monomials may be obtained by expanding Formula (3), as shown in Formula (7). In this case, an audio signal with five channels may be obtained. When the value of n in Formula (4) is 3, seven monomials may be obtained by expanding Formula (3), as shown in Formula (8). In this case, an audio signal with seven channels may be obtained.

$$B {1}_{3 , 0}^{0} = s \cdot {Y}_{3 , 0}^{0} ( {θ}_{s 1} , {φ}_{s 1} ) \qquad ( 5 )$$

$$B {1}_{3 , 1}^{0} = s \cdot {Y}_{3 , 1}^{0} ( {θ}_{s 1} , {φ}_{s 1} ) , B {1}_{3 , 1}^{- 1} = s \cdot {Y}_{3 , 1}^{- 1} ( {θ}_{s 1} , {φ}_{s 1} ) , B {1}_{3 , 1}^{1} = s \cdot {Y}_{3 , 1}^{1} ( {θ}_{s 1} , {φ}_{s 1} ) \qquad ( 6 )$$

$$B {1}_{3 , 2}^{0} = s \cdot {Y}_{3 , 2}^{0} ( {θ}_{s 1} , {φ}_{s 1} ) , B {1}_{3 , 2}^{- 1} = s \cdot {Y}_{3 , 2}^{- 1} ( {θ}_{s 1} , {φ}_{s 1} ) , B {1}_{3 , 2}^{1} = s \cdot {Y}_{3 , 2}^{1} ( {θ}_{s 1} , {φ}_{s 1} ) , B {1}_{3 , 2}^{- 2} = s \cdot {Y}_{3 , 2}^{- 2} ( {θ}_{s 1} , {φ}_{s 1} ) , B {1}_{3 , 2}^{2} = s \cdot {Y}_{3 , 2}^{2} ( {θ}_{s 1} , {φ}_{s 1} ) \qquad ( 7 )$$

$$B {1}_{3 , 3}^{0} = s \cdot {Y}_{3 , 3}^{0} ( {θ}_{s 1} , {φ}_{s 1} ) , B {1}_{3 , 3}^{- 1} = s \cdot {Y}_{3 , 3}^{- 1} ( {θ}_{s 1} , {φ}_{s 1} ) , B {1}_{3 , 2}^{1} = s \cdot {Y}_{3 , 2}^{1} ( {θ}_{s 1} , {φ}_{s 1} ) , B {1}_{3 , 3}^{- 2} = s \cdot {Y}_{3 , 3}^{- 2} ( {θ}_{s 1} , {φ}_{s 1} ) , B {1}_{3 , 2}^{2} = s \cdot {Y}_{3 , 2}^{2} ( {θ}_{s 1} , {φ}_{s 1} ) , B {1}_{3 , 3}^{- 3} = s \cdot {Y}_{3 , 3}^{- 3} ( {θ}_{s 1} , {φ}_{s 1} ) , B {1}_{3 , 3}^{3} = s \cdot {Y}_{3 , 3}^{3} ( {θ}_{s 1} , {φ}_{s 1} ) \qquad ( 8 )$$

Herein, (θₛ₁, φₛ₁) is location information of a sound source in the scene audio signal.

For example, if M=0, that is, m in Formula (3) is equal to 0, the value of n may be 0. One monomial may be obtained by expanding Formula (3). In this case, the second audio signal may include an audio signal with one channel, as shown in Formula (5); and the third audio signal may include an audio signal with other 15 channels, as shown in Formula (6) to Formula (8).

For example, if M=1, that is, m in Formula (3) is equal to 1, the value of n may be 0 and 1. Four monomials may be obtained by expanding Formula (3). In this case, the second audio signal may include an audio signal with four channels, as shown in Formula (5) and Formula (6); and the third audio signal may include an audio signal with other 12 channels, as shown in Formula (7) and Formula (8).

For example, if M=2, that is, m in Formula (3) is equal to 2, the value of n may be 0, 1, and 2. Nine monomials may be obtained by expanding Formula (3). In this case, the second audio signal may include an audio signal with nine channels, as shown in Formula (5) to Formula (7); and the third audio signal may include an audio signal with other seven channels, as shown in Formula (8).

For example, the N2-order HOA signal may include a sixth audio signal and a seventh audio signal, and the sixth audio signal is an HOA signal obtained when the N2-order HOA signal is truncated to an M-order HOA signal (in other words, the sixth audio signal is a 0th-order signal to an Mth-order signal in the N2-order HOA signal, the sixth audio signal includes an audio signal with (M+1)² channels, and M is an integer less than N2). The seventh audio signal is an audio signal in the N2-order HOA signal other than the sixth audio signal.

In a possible manner, the sixth audio signal may be referred to as a low-order part of the N2-order HOA signal, and the seventh audio signal may be referred to as a high-order part of the N2-order HOA signal.

For example, if N2=3, the N2-order HOA signal may include an audio signal with 16 channels.

For example, it can be learned, with reference to Formula (3), that when N is equal to 3 (that is, m in Formula (3) is equal to 3), 16 monomials may be obtained by expanding Formula (3). Each monomial may represent an audio signal with one channel in the N2-order HOA signal.

When a value of n in Formula (3) is 0, one monomial may be obtained by expanding Formula (3), as shown in Formula (9). In this case, an audio signal with one channel may be obtained. When the value of n in Formula (3) is 1, three monomials may be obtained by expanding Formula (3), as shown in Formula (10). In this case, an audio signal with three channels may be obtained. When a value of n in Formula (4) is 2, five monomials may be obtained by expanding Formula (3), as shown in Formula (11). In this case, an audio signal with five channels may be obtained. When the value of n in Formula (4) is 3, seven monomials may be obtained by expanding Formula (3), as shown in Formula (12). In this case, an audio signal with seven channels may be obtained.

$$B {2}_{3 , 0}^{0} = s \cdot {Y}_{3 , 0}^{0} ( {θ}_{s 2} , {φ}_{s 2} ) \qquad ( 9 )$$

$$B {2}_{3 , 1}^{0} = s \cdot {Y}_{3.1}^{0} ( {θ}_{s 2} , {φ}_{s 2} ) , B {2}_{3 , 1}^{- 1} = s \cdot {Y}_{3.1}^{- 1} ( {θ}_{s 2} , {φ}_{s 2} ) , B {2}_{3 , 1}^{1} = s \cdot {Y}_{3 , 1}^{1} ( {θ}_{s 2} , {φ}_{s 2} ) \qquad ( 10 )$$

$$B {2}_{3 , 2}^{0} = s \cdot {Y}_{3 , 2}^{0} ( {θ}_{s 2} , {φ}_{s 2} ) , B {2}_{3 , 2}^{- 1} = s \cdot {Y}_{3 , 2}^{- 1} ( {θ}_{s 2} , {φ}_{s 2} ) , B {2}_{3 , 2}^{1} = s \cdot {Y}_{3 , 2}^{1} ( {θ}_{s 2} , {φ}_{s 2} ) , B {2}_{3 , 2}^{- 2} = s \cdot {Y}_{3 , 2}^{- 2} ( {θ}_{s 2} , {φ}_{s 2} ) , B {2}_{3 , 2}^{2} = s \cdot {Y}_{3 , 2}^{2} ( {θ}_{s 2} , {φ}_{s 2} ) \qquad ( 11 )$$

$$B {2}_{3 , 3}^{0} = s \cdot {Y}_{3 , 3}^{0} ( {θ}_{s 2} , {φ}_{s 2} ) , B {2}_{3 , 3}^{- 1} = s \cdot {Y}_{3 , 3}^{- 1} ( {θ}_{s 2} , {φ}_{s 2} ) , B {2}_{3 , 2}^{1} = s \cdot {Y}_{3 , 2}^{1} ( {θ}_{s 2} , {φ}_{s 2} ) , B {2}_{3 , 3}^{- 2} = s \cdot {Y}_{3 , 3}^{- 2} ( {θ}_{s 2} , {φ}_{s 2} ) , B {2}_{3 , 2}^{2} = s \cdot {Y}_{3 , 2}^{2} ( {θ}_{s 2} , {φ}_{s 2} ) , B {2}_{3 , 3}^{- 3} = s \cdot {Y}_{3 , 3}^{- 3} ( {θ}_{s 2} , {φ}_{s 2} ) , B {2}_{3 , 3}^{3} = s \cdot {Y}_{3 , 3}^{3} ( {θ}_{s 2} , {φ}_{s 2} ) \qquad ( 12 )$$

Herein, (θₛ₂, φₛ₂) is location information of a sound source in the first reconstructed scene audio signal.

For example, if M=0, that is, m in Formula (3) is equal to 0, the value of n may be 0. One monomial may be obtained by expanding Formula (3). In this case, the sixth audio signal may include an audio signal with one channel, as shown in Formula (9); and the seventh audio signal may include an audio signal with other 15 channels, as shown in Formula (10) to Formula (12).

For example, if M=1, that is, m in Formula (3) is equal to 1, the value of n may be 0 and 1. Four monomials may be obtained by expanding Formula (3). In this case, the sixth audio signal may include an audio signal with four channels, as shown in Formula (9) and Formula (10); and the seventh audio signal may include an audio signal with other 12 channels, as shown in Formula (11) and Formula (12).

For example, if M=2, that is, m in Formula (3) is equal to 2, the value of n may be 0, 1, and 2. Nine monomials may be obtained by expanding Formula (3). In this case, the sixth audio signal may include an audio signal with nine channels, as shown in Formula (9) to Formula (11); and the seventh audio signal may include an audio signal with other seven channels, as shown in Formula (12).

The following describes a process of selecting a target virtual speaker in an encoding process and a process of reconstructing a second reconstructed scene audio signal in a decoding process.

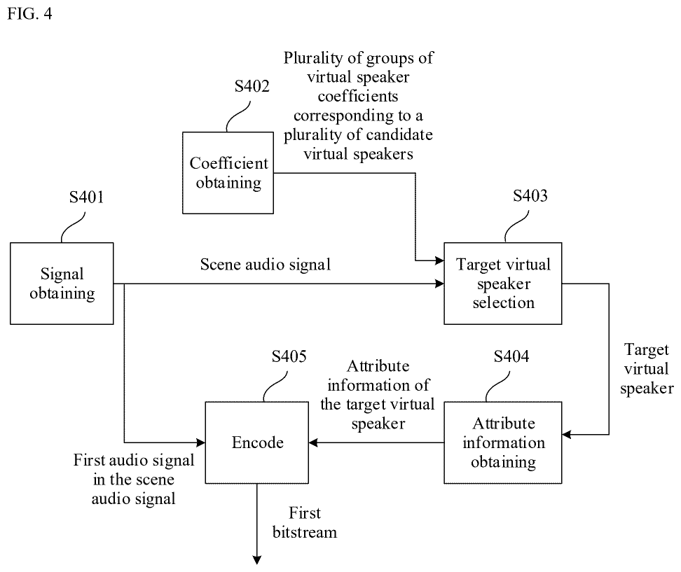

FIG. 4 is a diagram of an example encoding process.
S401: Obtain a to-be-encoded scene audio signal, where the scene audio signal includes an audio signal with C1 channels, and C1 is a positive integer.

For example, for S401, refer to the descriptions of S201. Details are not described herein again.
S402: Obtain a plurality of groups of virtual speaker coefficients corresponding to a plurality of candidate virtual speakers, where the plurality of groups of virtual speaker coefficients are in a one-to-one correspondence with the plurality of candidate virtual speakers.

For example, first configuration information of an encoding module (for example, a scene audio encoding module) may be obtained; second configuration information of a candidate virtual speaker is determined based on the first configuration information of the encoding module; and the plurality of candidate virtual speakers are generated based on second configuration information of the candidate virtual speaker.

For example, the first configuration information includes but is not limited to an encoding bit rate and user-defined information (for example, an HOA order quantity (which is an order quantity of an HOA signal that may be encoded by the encoding module) corresponding to the encoding module, an order quantity of a reconstructed scene audio signal (an expected order quantity of a reconstructed HOA signal obtained by a decoder side through decoding), and a format of the reconstructed scene audio signal (an expected format of the reconstructed HOA signal obtained by the decoder side through decoding)). This is not limited in this disclosure.

For example, the second configuration information includes but is not limited to information such as a total quantity of candidate virtual speakers, an HOA order quantity of each candidate virtual speaker, and location information of each candidate virtual speaker. This is not limited in this disclosure.

For example, the second configuration information of the candidate virtual speaker may be determined based on the first configuration information of the encoding module in a plurality of manners. For example, a small quantity of candidate virtual speakers may be configured if the encoding bit rate is low; and a plurality of candidate virtual speakers may be configured if the encoding bit rate is high. For another example, the HOA order quantity of the virtual speaker may be configured as the HOA order quantity of the encoding module. In this embodiment, in addition to determining the second configuration information of the candidate virtual speaker based on the first configuration information of the encoding module, the second configuration information of the candidate virtual speaker may also be determined based on the user-defined information (for example, the total quantity of candidate virtual speakers, the HOA order quantity of each candidate virtual speaker, and the location information of each candidate virtual speaker that may be customized by a user). This is not limited.

For example, a configuration table may be preset. The configuration table includes a relationship between a quantity of candidate virtual speakers and location information of the candidate virtual speakers. In this way, after the total quantity of candidate virtual speakers is determined, the location information of each candidate virtual speaker may be determined by searching the configuration table.

For example, after the second configuration information of the candidate virtual speaker is determined, the plurality of candidate virtual speakers may be generated based on the second configuration information of the candidate virtual speaker. For example, a corresponding quantity of candidate virtual speakers may be generated based on the total quantity of candidate virtual speakers, and the HOA order quantity of each candidate virtual speaker is set based on the HOA order quantity of each candidate virtual speaker; and a location of each candidate virtual speaker is set based on the location information of each candidate virtual speaker.

For example, when each candidate virtual speaker serves as a virtual sound source, a virtual speaker signal generated by the virtual sound source is a plane wave, and the plane wave may be expanded in a spherical coordinate system. For an ideal plane wave whose amplitude is s and direction is (θₛ, φₛ), a form obtained through expansion based on a spherical harmonic function may be shown in Formula (3). The HOA order quantity of the candidate virtual speaker is a truncated value of m in Formula (3).

Then, a virtual speaker coefficient corresponding to each candidate virtual speaker may be determined based on the HOA order quantity of each candidate virtual speaker (each candidate virtual speaker corresponds to a group of virtual speaker coefficients). For example, for a candidate virtual speaker, with reference to Formula (3), the truncated value of m in Formula (3) is set to the HOA order quantity of the candidate virtual speaker, and (θₛ, φₛ) in Formula (3) is set to the location information (θₛ₃, φₛ₃) of the candidate virtual speaker. In this case, B_{m,n}^{σ} in Formula (3) is a group of virtual speaker coefficients (the virtual speaker coefficient is also an HOA coefficient. It should be noted that, it can be learned from Formula (3) that when a location of the candidate virtual speaker is different from a location of a sound source in the scene audio signal, the virtual speaker coefficient of the candidate virtual speaker and the scene audio signal are different HOA coefficients). In this way, a group of virtual speaker coefficients corresponding to each candidate virtual speaker may be determined.

The group of virtual speaker coefficients that corresponds to the candidate virtual speakers and that is determined in S402 may include C1 virtual speaker coefficients, and one virtual speaker coefficient corresponds to one channel of the scene audio signal.

In a possible manner, the second configuration information of the candidate virtual speaker is determined based on the first configuration information of the encoding module (which is subsequently replaced by “step A”); the plurality of candidate virtual speakers are generated based on the second configuration information of the candidate virtual speaker (which is subsequently replaced by “step B”); and the virtual speaker coefficient corresponding to each candidate virtual speaker is determined (which is subsequently replaced by “step C”). The three steps may be performed in advance, that is, performed before the to-be-encoded scene audio signal is obtained.

In a possible manner, step A and step B are performed in advance, and step C is performed after the to-be-encoded scene audio signal is obtained.

In a possible manner, step A is performed in advance, and step B and step C are performed after the to-be-encoded scene audio signal is obtained.

In a possible manner, step A, step B, and step C are all performed after the to-be-encoded scene audio signal is obtained.
S403: Select a target virtual speaker from the plurality of candidate virtual speakers based on the scene audio signal and the plurality of groups of virtual speaker coefficients.

For example, a dot product of the scene audio signal and each of the plurality of groups of virtual speaker coefficients is obtained, to obtain a plurality of dot product values. The plurality of dot product values are in a one-to-one correspondence with the plurality of groups of virtual speaker coefficients. For example, a dot product of a group of virtual speaker coefficients corresponding to each of the plurality of candidate virtual speakers and the scene audio signal may be obtained, to obtain a corresponding dot product value.

Then, the target virtual speaker may be selected from the plurality of candidate virtual speakers based on the plurality of dot product values. In a possible manner, first G (G is a positive integer) candidate virtual speakers with largest dot product values may be selected as target virtual speakers. In a possible manner, a candidate virtual speaker with a largest dot product may be first selected as a target virtual speaker; the scene audio signal is projected and superimposed on a linear combination of a group of virtual speaker coefficients corresponding to the candidate virtual speaker with the largest dot product, to obtain a projection vector; and the projection vector is subtracted from the scene audio signal, to obtain a difference. Then, the foregoing process is repeated for the difference, to implement iterative calculation, and one target virtual speaker is generated each time of iteration.

In a possible manner, one frame of scene audio signal may be used as a unit, and a dot product value between a scene audio signal of each frame of scene audio signal and the virtual speaker coefficient corresponding to each candidate virtual speaker is determined. In this way, a target virtual speaker corresponding to each frame of scene audio signal may be determined.

In a possible manner, one frame of scene audio signal may be split into a plurality of subframes, and then a dot product value between each subframe and the virtual speaker coefficient corresponding to each candidate virtual speaker is determined. In this way, a target virtual speaker corresponding to each subframe may be determined.
S404: Obtain attribute information of the target virtual speaker.

In a possible manner, the attribute information of the target virtual speaker is generated based on location information of the target virtual speaker. In a possible manner, the location information (including pitch angle information and horizontal angle information) of the target virtual speaker may be used as the attribute information of the target virtual speaker. In a possible manner, a location index (including a pitch angle index (which may be used to uniquely identify the pitch angle information) and a horizontal angle index (which may be used to uniquely identify the horizontal angle information)) corresponding to the location information of the target virtual speaker are used as the attribute information of the target virtual speaker.

In a possible manner, a virtual speaker index (for example, a virtual speaker identifier) of the target virtual speaker may be used as the attribute information of the target virtual speaker. The virtual speaker index is in a one-to-one correspondence with the location information.

In a possible manner, the virtual speaker coefficient of the target virtual speaker may be used as the attribute information of the target virtual speaker. For example, C2 virtual speaker coefficients of the target virtual speaker may be determined, and the C2 virtual speaker coefficients of the target virtual speaker are used as the attribute information of the target virtual speaker. The C2 virtual speaker coefficients of the target virtual speaker are in a one-to-one correspondence with an audio signal with C2 channels included in a first reconstructed scene audio signal.

It should be noted that, a data amount of the virtual speaker coefficient is far greater than a data amount of the location information, a data amount of an index of the location information, and a data amount of a virtual speaker index. Specific information that is in the location information, the index of the location information, the virtual speaker index, and the virtual speaker coefficient and that is used as the attribute information of the target virtual speaker may be determined based on a bandwidth. For example, when the bandwidth is large, the virtual speaker coefficient may be used as the attribute information of the target virtual speaker. In this way, the decoder side does not need to calculate the virtual speaker coefficient of the target virtual speaker, and computational power of the decoder side may be saved. When the bandwidth is small, any one of the location information, the index of the location information, and the virtual speaker index may be used as the attribute information of the target virtual speaker. In this way, a bit rate may be reduced. It should be understood that, specific information that is in the location information, the index of the location information, the virtual speaker index, and the virtual speaker coefficient and that is used as the attribute information of the target virtual speaker may alternatively be preset. This is not limited in this disclosure.
S405: Encode a first audio signal in the scene audio signal and the attribute information of the target virtual speaker, to obtain a first bitstream.

In a possible manner, the first audio signal is a second audio signal. In other words, the first audio signal is a low-order part of the scene audio signal. It is assumed that N1=3. When M=0, the first audio signal includes an audio signal with one channel. For example, the first audio signal is an audio signal with one channel in Formula (5). When M=1, the first audio signal includes an audio signal with four channels. For example, the first audio signal includes an audio signal with four channels in Formula (5) and Formula (6). When M=2, the first audio signal includes an audio signal with nine channels. For example, the first audio signal includes an audio signal with nine channels in Formula (5), Formula (6), and Formula (7).

For example, a quantity of channels included in the second audio signal may be an odd number or an even number. For example, based on the foregoing example, it is assumed that N1=3. When M=0 and M=2, the quantity of channels included in the second audio signal is an odd number; and when M=1, the quantity of channels included in the second audio signal is an even number. Some encoders support encoding only an audio signal with an even quantity of channels. Therefore, in a possible manner, the first audio signal may include the second audio signal and a fourth audio signal, and the fourth audio signal is an audio signal with some channels in the third audio signal. For example, when the second audio signal includes an odd quantity of channels, an audio signal with an odd quantity of channels may be selected from the third audio signal as the fourth audio signal. In other words, the fourth audio signal may include the audio signal with the odd quantity of channels. For example, when M=0, the first audio signal may include an audio signal with one channel in Formula (5) and an audio signal with one channel represented by a first item of Formula (6). In this case, the first audio signal includes an audio signal with two channels. For example, when M=2, the first audio signal may include an audio signal with nine channels in Formula (5) to Formula (7) and an audio signal with one channel represented by a first item of Formula (8). In this case, the first audio signal includes an audio signal with 10 channels.

When the second audio signal includes an even quantity of channels, an audio signal with an even quantity of channels may be selected from the third audio signal as the fourth audio signal. For example, when M=1, the first audio signal may include Formula (5), Formula (6), and first two items of Formula (7). In this case, the first audio signal includes an audio signal with six channels.

It should be understood that, when the second audio signal includes an even quantity of channels, an audio signal with some channels may not be selected from the third audio signal, but the second audio signal is directly used as the first audio signal.

It should be understood that a quantity of channels of an audio signal included in the first audio signal may be determined based on a requirement and a bandwidth. This is not limited in this disclosure.

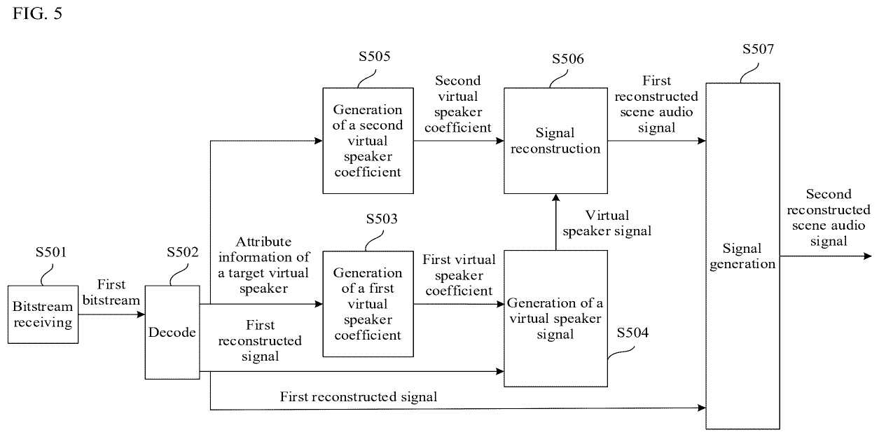

FIG. 5 is a diagram of an example decoding process. FIG. 5 shows a decoding process corresponding to the encoding process in FIG. 4.
S501: Receive a first bitstream.
S502: Decode the first bitstream, to obtain a first reconstructed signal and attribute information of a target virtual speaker.

For example, for S501 and S502, refer to the descriptions of S301 and S302. Details are not described herein again.

For example, for S303, refer to the descriptions of S503 and S504.
S503: Determine, based on the attribute information, a first virtual speaker coefficient corresponding to the target virtual speaker.

For example, an encoder side may write M into the first bitstream, and further, M may be obtained from the first bitstream through decoding (certainly, the encoder side and a decoder side may also pre-agree on M, and this is not limited in this disclosure). For example, when the attribute information of the target virtual speaker is location information, the location information of the target virtual speaker may be substituted into Formula (3), and m in Formula (3) is equal to M, so that the first virtual speaker coefficient corresponding to the target virtual speaker may be obtained. The first virtual speaker coefficient includes (M+1)² virtual speaker coefficients, and the (M+1)² virtual speaker coefficients correspond to (M+1)² channels of a second reconstructed signal. The second reconstructed signal is a reconstructed signal of a second audio signal.

For example, when the attribute information of the target virtual speaker is a location index of the location information, the location information of the target virtual speaker may be determined based on a relationship between location information and a location index; and then the first virtual speaker coefficient is determined in the foregoing manner. This is not described herein again.

For example, when the attribute information of the target virtual speaker is a virtual speaker index, the location information of the target virtual speaker may be determined based on a relationship between location information and a virtual speaker index; and then the first virtual speaker coefficient is determined in the foregoing manner. This is not described herein again.

For example, when the attribute information of the target virtual speaker is a virtual speaker coefficient, it can be learned, based on the foregoing descriptions, that a group of virtual speaker coefficients corresponding to the target virtual speaker includes C2 virtual speaker coefficients. In this case, (M+1)² virtual speaker coefficients corresponding to (M+1)² channels included in the second reconstructed signal may be selected as the first virtual speaker coefficient.
S504: Generate a virtual speaker signal based on the first reconstructed signal and the first virtual speaker coefficient.

For example, the virtual speaker signal may be generated based on a second reconstructed signal in the first reconstructed signal and the first virtual speaker coefficient.

For example, it is assumed that a matrix A whose size is (Y1×P) represents the first virtual speaker coefficient of the target virtual speaker. Herein, Y1 (Y1 is a positive integer) is a quantity of target virtual speakers, and P is a quantity (M+1)² of channels of an audio signal included in the second reconstructed signal. In addition, a matrix X whose size is (L×P) represents the second reconstructed signal. Herein, L is a quantity of sampling points of the second reconstructed signal. A theoretical optimal solution w is obtained in a least square method, and w represents the virtual speaker signal, as shown in Formula (13).

$$w = {A}^{- 1} X \qquad ( 13 )$$

A matrix A⁻¹ is an inverse matrix of the matrix A.

For example, for S304, refer to S505 and S506.
S505: Determine, based on the attribute information of the target virtual speaker, a second virtual speaker coefficient corresponding to the target virtual speaker.

For example, it may be determined, based on an expected order quantity N2 of a reconstructed scene audio signal (namely, an order quantity N2 of a first reconstructed scene audio signal or a second reconstructed scene audio signal), that m in Formula (3) is equal to N2. Then, when the attribute information of the target virtual speaker is the location information, the location information of the target virtual speaker may be substituted into Formula (3), and m in Formula (3) is equal to N2, so that the second virtual speaker coefficient may be obtained. The second virtual speaker coefficient includes C2 virtual speaker coefficients, and the C2 virtual speaker coefficients correspond to C2 channels of the first reconstructed scene audio signal.

For example, when the attribute information of the target virtual speaker is the location index of the location information, the location information of the target virtual speaker may be determined based on a relationship between location information and a location index; and then the first virtual speaker coefficient is determined in the foregoing manner. This is not described herein again.

For example, when the attribute information of the target virtual speaker is the virtual speaker index, the location information of the target virtual speaker may be determined based on a relationship between location information and a virtual speaker index; and then the first virtual speaker coefficient is determined in the foregoing manner. This is not described herein again.

For example, when the attribute information of the target virtual speaker is the virtual speaker coefficient, the attribute information of the target virtual speaker may be directly used as the second virtual speaker coefficient.
S506: Obtain the first reconstructed scene audio signal based on the virtual speaker signal and the second virtual speaker coefficient.

For example, it is assumed that a matrix A whose size is (Y1×C2) represents the second virtual speaker coefficient. Y1 is the quantity of target virtual speakers, and C2 is a quantity of channels of the first reconstructed scene audio signal. In addition, a matrix B whose size is (L×Y1) represents the virtual speaker signal. L is a quantity of sampling points of the first reconstructed scene audio signal. In this case, the first reconstructed scene audio signal may be represented by H, as shown in Formula (14).

$$H = B A \qquad ( 14 )$$

S507: Generate the second reconstructed scene audio signal based on the first reconstructed signal and the first reconstructed scene audio signal.

For example, the first reconstructed signal obtained through decoding is closer to a first audio signal encoded by the encoder side than an audio signal corresponding to a channel in the first reconstructed scene audio signal and an audio signal corresponding to a channel in the first audio signal. Further, the second reconstructed scene audio signal is generated based on the first reconstructed scene audio signal and the first reconstructed signal. Then, the second reconstructed scene audio signal is used as a final decoding result, and a reconstructed scene audio signal with higher audio quality can be obtained.

In a possible manner, when the first audio signal includes the second audio signal (the first audio signal is the second audio signal, or the first audio signal includes the second audio signal and the fourth audio signal), the first reconstructed signal is the second reconstructed signal. In this case, the second reconstructed scene audio signal may be generated based on the second reconstructed signal and a seventh audio signal. For example, the second reconstructed signal and the seventh audio signal may be spliced based on channels, to generate the second reconstructed scene audio signal.

For example, if the second audio signal is a signal with one channel in Formula (5), the first audio signal is the second audio signal, and the sixth audio signal is a signal with 15 channels in Formula (10) to Formula (12), the obtained second reconstructed scene audio signal may include a reconstructed signal of an audio signal with one channel in Formula (5) and a signal with 15 channels in Formula (10) to Formula (12).

For example, if the second audio signal includes a signal with one channel in Formula (5), the fourth audio signal is a signal with one channel represented by a first item in Formula (6), the first audio signal includes the second audio signal and the fourth audio signal, and the sixth audio signal is a signal with 15 channels in Formula (10) to Formula (12), the obtained second reconstructed scene audio signal may include a reconstructed signal of an audio signal with one channel in Formula (5) and a signal with 15 channels in Formula (10) to Formula (12).

In a possible manner, when the first audio signal includes the second audio signal and the fourth audio signal, the first reconstructed signal may include the second reconstructed signal and a fourth reconstructed signal (the fourth reconstructed signal is a reconstructed signal of the fourth audio signal). In this case, the second reconstructed scene audio signal may be generated based on the second reconstructed signal, the fourth reconstructed signal, and the eighth audio signal. The eighth audio signal is an audio signal with some channels in the seventh audio signal, and the eighth audio signal is an audio signal with a channel in the seventh audio signal other than a channel corresponding to the fourth audio signal. For example, the second reconstructed signal, the fourth reconstructed signal, and the eighth audio signal may be spliced based on channels, to generate the second reconstructed scene audio signal.

For example, if the second audio signal includes a signal with one channel in Formula (5), the fourth audio signal is a signal with one channel represented by a first item in Formula (6), and the first audio signal includes the second audio signal and the fourth audio signal, the eighth audio signal is a signal with two channels represented by last two items in Formula (10) and a signal with 12 channels in Formula (11) and Formula (12). Therefore, the obtained second reconstructed scene audio signal may include a reconstructed signal of an audio signal with one channel in Formula (5), a reconstructed signal of an audio signal with one channel represented by a first item in Formula (6), a signal with two channels represented by last two items in Formula (10), and a signal with 12 channels in Formula (11) and Formula (12).

For example, the second reconstructed scene audio signal may be an N2-order HOA signal. N2 is a positive integer. For example, the second reconstructed scene audio signal may include an audio signal with C2 channels. C2=(N2+1)².

For example, an order quantity N2 of the second reconstructed scene audio signal may be greater than or equal to an order quantity N1 of the scene audio signal. Correspondingly, a quantity C2 of channels of the audio signal included in the second reconstructed scene audio signal may be greater than or equal to a quantity C1 of channels of the audio signal included in the scene audio signal.

For example, when the order quantity N2 of the second reconstructed scene audio signal is equal to the order quantity N1 of the scene audio signal, the decoder side may reconstruct a reconstructed scene audio signal whose order quantity is the same as an order quantity of the scene audio signal encoded by the encoder side.

For example, when the order quantity N2 of the second reconstructed scene audio signal is greater than the order quantity N1 of the scene audio signal, the decoder side may reconstruct a reconstructed scene audio signal whose order quantity is greater than an order quantity of the scene audio signal encoded by the encoder side.

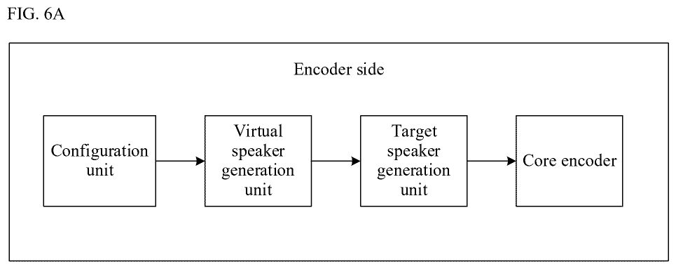

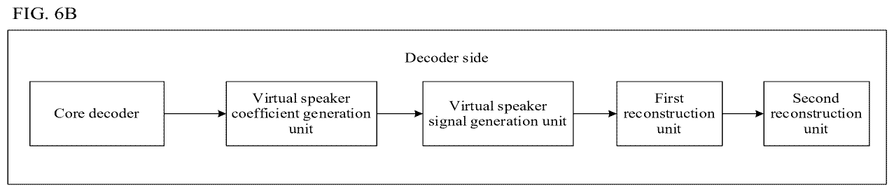

FIG. 6A is a diagram of an example structure of an encoder side.

As shown in FIG. 6A, for example, the encoder side may include a configuration unit, a virtual speaker generation unit, a target speaker generation unit, and a core encoder. It should be understood that FIG. 6A is merely an example. The encoder side disclosure may include more or fewer modules than those shown in FIG. 6A. Details are not described herein again.

For example, the configuration unit may be configured to determine second configuration information of a candidate virtual speaker based on first configuration information of an encoding module.

For example, the virtual speaker generation unit may be configured to: generate a plurality of candidate virtual speakers based on the second configuration information of the candidate virtual speaker, and determine a virtual speaker coefficient corresponding to each candidate virtual speaker.

For example, the target speaker generation unit may be configured to: select a target virtual speaker from the plurality of candidate virtual speakers based on a scene audio signal and a plurality of groups of virtual speaker coefficients, and determine attribute information of the target virtual speaker.

For example, the core encoder may be configured to encode the first audio signal in the scene audio signal and the attribute information of the target virtual speaker.

For example, the scene audio encoding module in FIG. 1A and FIG. 1B may include the configuration unit, the virtual speaker generation unit, the target speaker generation unit, and the core encoder in FIG. 6A; or include only the core encoder.

FIG. 6B is a diagram of an example structure of a decoder side.

As shown in FIG. 6B, for example, the decoder side may include a core decoder, a virtual speaker coefficient generation unit, a virtual speaker signal generation unit, a first reconstruction unit, and a second reconstruction unit. It should be understood that FIG. 6B is merely an example. The decoder side may include more or fewer modules than those shown in FIG. 6B. Details are not described herein again.

For example, the core decoder may be configured to decode a first bitstream, to obtain a first reconstructed signal and attribute information of a target virtual speaker.

For example, the virtual speaker coefficient generation unit may be configured to determine a first virtual speaker coefficient and a second virtual speaker coefficient based on the attribute information of the target virtual speaker.

For example, the virtual speaker signal generation unit may be configured to generate a virtual speaker signal based on the first reconstructed signal and the first virtual speaker coefficient.

For example, the first reconstruction unit may be configured to obtain a first reconstructed scene audio signal based on the virtual speaker signal and the second virtual speaker coefficient.

For example, the second reconstruction unit may be configured to generate a second reconstructed scene audio signal based on the first reconstructed signal and the first reconstructed scene audio signal.

For example, the scene audio decoding module in FIG. 1A and FIG. 1B may include the core decoder, the virtual speaker coefficient generation unit, the virtual speaker signal generation unit, the first reconstruction unit, and the second reconstruction unit in FIG. 6B; or include only the core decoder.

In a possible manner, in an encoding process, feature information corresponding to a fifth audio signal (the fifth audio signal is a third audio signal, or the fifth audio signal is an audio signal in the scene audio signal other than a second audio signal and a fourth audio signal) in the scene audio signal may be further extracted, and encoded and sent for decoding. After receiving a bitstream, the decoder side may compensate a seventh audio signal/an eighth audio signal in the first reconstructed scene audio signal based on the feature information, so that audio quality of the seventh audio signal/the eighth audio signal in the first reconstructed scene audio signal/the second reconstructed scene audio signal can be improved.

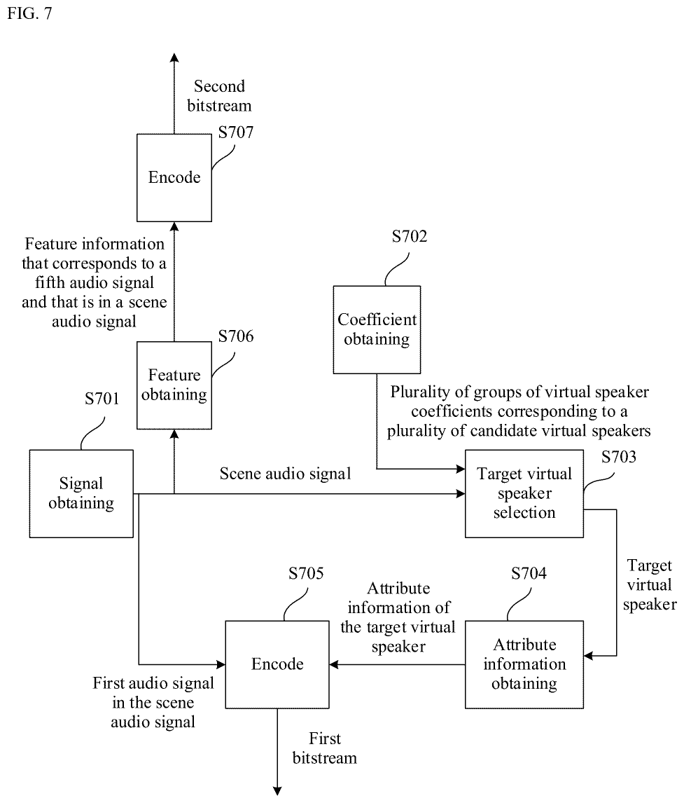

FIG. 7 is a diagram of an example encoding process.
S701: Obtain a to-be-encoded scene audio signal, where the scene audio signal includes an audio signal with C1 channels, and C1 is a positive integer.
S702: Obtain a plurality of groups of virtual speaker coefficients corresponding to a plurality of candidate virtual speakers, where the plurality of groups of virtual speaker coefficients are in a one-to-one correspondence with the plurality of candidate virtual speakers.
S703: Select a target virtual speaker from the plurality of candidate virtual speakers based on the scene audio signal and the plurality of groups of virtual speaker coefficients.
S704: Obtain attribute information of the target virtual speaker.
S705: Encode a first audio signal in the scene audio signal and the attribute information of the target virtual speaker, to obtain a first bitstream.

For example, for S701 to S705, refer to the descriptions of S401 to S405. Details are not described herein again.
S706: Obtain feature information that corresponds to a fifth audio signal and that is in the scene audio signal.

In a possible manner, when the first audio signal is a second audio signal, or the first audio signal includes a second audio signal and a fourth audio signal, the fifth audio signal is a third audio signal.

For example, it is assumed that N1=3 and M=0. If the first audio signal is the second audio signal, and the second audio signal is an audio signal with one channel in Formula (5), the fifth audio signal may be an audio signal with 15 channels in Formula (6) to Formula (9). If the first audio signal includes the second audio signal and the fourth audio signal, the second audio signal is an audio signal with one channel in Formula (5), and the fourth audio signal is an audio signal with one channel represented by a first item in Formula (6), the fifth audio signal may be an audio signal with 15 channels in Formula (6) to Formula (9).

In a possible manner, when the first audio signal includes the second audio signal and the fourth audio signal, the fifth audio signal may be an audio signal in the scene audio signal other than the second audio signal and the fourth audio signal.

For example, it is assumed that N1=3 and M=0. If the first audio signal includes the second audio signal and the fourth audio signal, the second audio signal is an audio signal with one channel in Formula (5), and the fourth audio signal is an audio signal with one channel represented by a first item in Formula (6), the fifth audio signal may be an audio signal with two channels represented by last two items in Formula (6) and an audio signal with 12 channels in Formula (7) to Formula (9).

For example, the scene audio signal may be analyzed, to determine information such as strength and energy of the scene audio signal; and then the feature information that corresponds to the fifth audio signal and that is in the scene audio signal is extracted based on the information such as the strength and the energy of the scene audio signal.

Feature information corresponding to the scene audio signal includes but is not limited to gain information and diffusion information.

For example, gain information Gain(i) corresponding to the fifth audio signal in the scene audio signal may be calculated with reference to Formula (15):

$$Gain ( i ) = E ( i ) / E ( 1 ) \qquad ( 15 )$$

Herein, i is a channel number of a channel included in the fifth audio signal in the scene audio signal, E(i) is energy of an i^{th} channel, and E(1) is energy of an audio signal with C1 channels in the scene audio signal.
S707: Encode the feature information, to obtain a second bitstream.

For example, the feature information corresponding to the first audio signal in the scene audio signal may be encoded, to obtain the second bitstream. Subsequently, the second bitstream may be sent to a decoder side. In this way, the decoder side may compensate a seventh audio signal/an eighth audio signal in a first reconstructed scene audio signal based on the feature information that corresponds to the fifth audio signal and that is in the scene audio signal, to obtain improved audio quality of the first reconstructed scene audio signal.

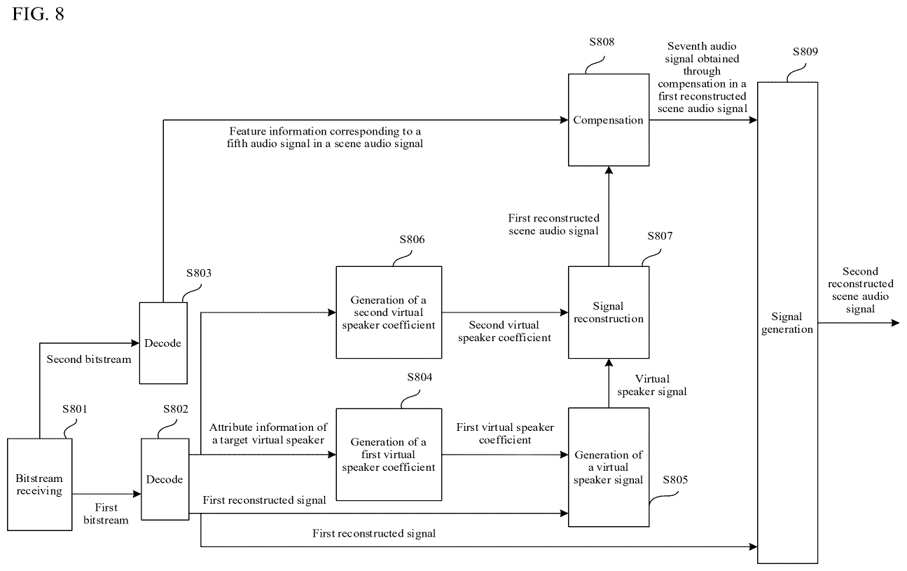

FIG. 8 is a diagram of an example decoding process. FIG. 8 shows a decoding process corresponding to the encoding process in FIG. 7.
S801: Receive a first bitstream and a second bitstream.
S802: Decode the first bitstream, to obtain a first reconstructed signal and attribute information of a target virtual speaker.
S803. Decode the second bitstream, to obtain feature information corresponding to a fifth audio signal in a scene audio signal obtained through decoding.

It should be understood that, when an encoder side performs lossy compression on feature information, there is a difference between feature information obtained by the decoder side through decoding and the feature information encoded by the encoder side. When the encoder side performs lossless compression on feature information, feature information obtained by the decoder side through decoding is the same as the feature information encoded by the encoder side. (In this disclosure, feature information encoded by the encoder side and feature information obtained by the decoder side through decoding are not distinguished by name.)
S804: Determine a first virtual speaker coefficient based on the attribute information.
S805: Generate a virtual speaker signal based on the first reconstructed signal and the first virtual speaker coefficient.
S806: Determine a second virtual speaker coefficient based on the attribute information.
S807: Obtain a first reconstructed scene audio signal based on the virtual speaker signal and the second virtual speaker coefficient.

For example, for S801 to S807, refer to the descriptions of S501 to S506. Details are not described herein again.
S808: Compensate a seventh audio signal in the first reconstructed scene audio signal based on the feature information.

For example, the seventh audio signal in the first reconstructed scene audio signal may be compensated based on the feature information that corresponds to the fifth audio signal and that is in the scene audio signal, to improve quality of the seventh audio signal in the first reconstructed scene audio signal.

For example, when the feature information is gain information, compensation may be performed with reference to Formula (16):

$$E ( i ) = Gain ( i ) * E ( 1 ) \qquad ( 16 )$$

Herein, i is a channel number of a channel included in the seventh audio signal in the first reconstructed scene audio signal, E(i) is energy of an i^{th} channel, E(1) is energy of an audio signal with C2 channels in the first reconstructed scene audio signal, and Gain(i) is gain information corresponding to an audio signal with an i^{th} channel in the fifth audio signal in the scene audio signal.
S809: Generate a second reconstructed scene audio signal based on a second reconstructed signal and the seventh audio signal.

For example, the seventh audio signal in S809 is a seventh audio signal obtained through compensation based on the feature information. For S809, refer to the foregoing descriptions. Details are not described herein again.

It should be understood that, an eighth audio signal in the first reconstructed scene audio signal is compensated based on the feature information, and the second reconstructed scene audio signal is generated based on the second reconstructed signal, a fourth reconstructed signal, and the eighth audio signal (an eighth audio signal obtained through compensation based on the feature information) in the first reconstructed scene audio signal. For details, refer to the descriptions of S808 and S809. Details are not described herein again.

It should be understood that, S808 may be performed even if S809 is not performed. The first reconstructed scene audio signal may be compensated, and a first reconstructed scene audio signal obtained through compensation is used as a final reconstructed scene audio signal. In this way, audio quality of the final reconstructed scene audio signal can also be improved.

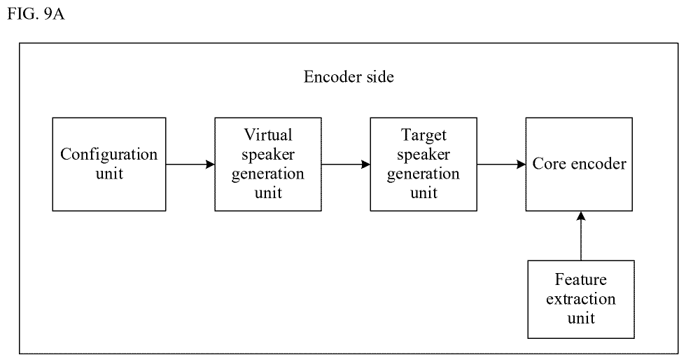

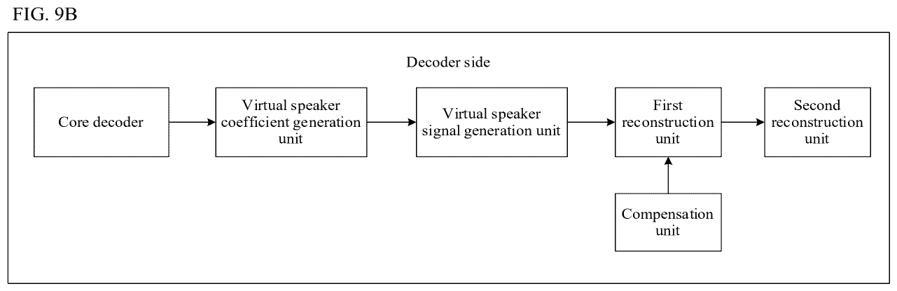

FIG. 9A is a diagram of an example structure of an encoder side. FIG. 9A shows a structure of an encoder side shown based on FIG. 6A.

As shown in FIG. 9A, for example, the encoder side may include a configuration unit, a virtual speaker generation unit, a target speaker generation unit, a core encoder, and a feature extraction unit. It should be understood that FIG. 9A is merely an example. The encoder side disclosure may include more or fewer modules than those shown in FIG. 9A. Details are not described herein again.

For example, for the configuration unit, the virtual speaker generation unit, and the target speaker generation unit in FIG. 9A, refer to the descriptions in FIG. 6A. Details are not described herein again.

For example, the feature extraction unit may be configured to obtain feature information corresponding to a fifth audio signal in a scene audio signal.

For example, the core encoder may be configured to: encode a first audio signal in the scene audio signal and attribute information of a target virtual speaker, to obtain a first bitstream; and encode the feature information that corresponds to the fifth audio signal and that is in the scene audio signal, to obtain a second bitstream.

For example, the scene audio encoding module in FIG. 1A and FIG. 1B may include the configuration unit, the virtual speaker generation unit, the target speaker generation unit, the core encoder, and the feature extraction unit in FIG. 9A; or include only the core encoder.

FIG. 9B is a diagram of an example structure of a decoder side.

As shown in FIG. 9B, for example, the decoder side may include a core decoder, a virtual speaker coefficient generation unit, a virtual speaker signal generation unit, a first reconstruction unit, a compensation unit, and a second reconstruction unit. It should be understood that FIG. 9B is merely an example. The decoder side may include more or fewer modules than those shown in FIG. 9B. Details are not described herein again.

For example, for the virtual speaker coefficient generation unit, the virtual speaker signal generation unit, and the first reconstruction unit in FIG. 9B, refer to the descriptions in FIG. 6B. Details are not described herein again.

For example, the core decoder may be configured to decode a first bitstream, to obtain a first reconstructed signal and attribute information of a target virtual speaker; and may be further configured to decode a second bitstream, to obtain feature information corresponding to a fifth audio signal in a scene audio signal.

For example, the compensation unit may be configured to compensate a seventh audio signal/an eighth audio signal based on the feature information corresponding to the fifth audio signal.

For example, the second reconstruction unit may be configured to: generate a second reconstructed scene audio signal based on a second reconstructed signal and a seventh audio signal obtained through compensation; or generate a second reconstructed scene audio signal based on a second reconstructed signal, a fourth reconstructed signal, and an eighth audio signal obtained through compensation.

For example, the scene audio decoding module in FIG. 1A and FIG. 1B may include the core decoder, the virtual speaker coefficient generation unit, the virtual speaker signal generation unit, the first reconstruction unit, the compensation unit, and the second reconstruction unit in FIG. 9B; or include only the core decoder.

The foregoing describes encoding and decoding processes by using an example. For example, a to-be-encoded scene audio signal is a three-order HOA signal, and includes 16 channels. It is assumed that an encoder side selects four target virtual speakers, and K=9. In this case, an audio signal with nine channels in the scene audio signal and attribute information of four target virtual speakers may be encoded, to obtain a first bitstream; and feature information corresponding to an audio signal with other seven channels in the scene audio signal may be encoded, to obtain a second bitstream. The encoder side sends the first bitstream and the second bitstream to a decoder side. The decoder side decodes the first bitstream, to obtain the attribute information of the four target virtual speakers and the audio signal with the nine channels in the scene audio signal; and decodes the second bitstream, to obtain the feature information corresponding to the audio signal with the other seven channels in the scene audio signal. Then, four virtual speaker signals may be generated based on the attribute information of the four target virtual speakers and the audio signal with the nine channels in the scene audio signal. Finally, a first reconstructed scene audio signal, namely, the three-order HOA signal, is generated based on the four virtual speaker signals and the attribute information of the four target virtual speakers. Then, corresponding feature information obtained through decoding is applied to the audio signal with the seven corresponding channels in the first reconstructed scene audio signal; and then the audio signal with the nine channels in the scene audio signal that are obtained through decoding and the audio signal with the seven channels in the compensated first reconstructed scene audio signal that are obtained through compensation are spliced based on channels, to obtain a second reconstructed scene audio signal. The second reconstructed scene audio signal is a three-order HOA signal, and includes 16 channels.

According to a test, at a rate of 768 kbps, encoding effect disclosure is better than encoding effect in some technologies, to achieve transparent sound quality and no direction deviation.

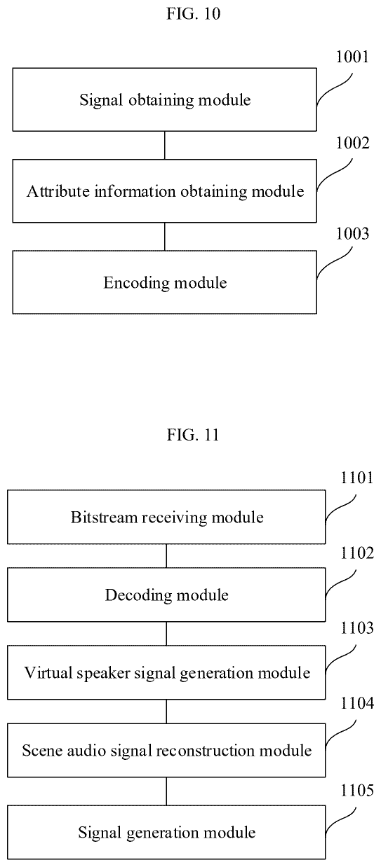

FIG. 10 is a diagram of an example structure of a scene audio encoding apparatus. The scene audio encoding apparatus in FIG. 10 may be configured to perform the encoding method in the foregoing embodiment. Therefore, for beneficial effects that can be achieved by the scene audio encoding apparatus, refer to beneficial effects in the corresponding method provided above. Details are not described herein again. The scene audio encoding apparatus may include:
a signal obtaining module 1001, configured to obtain a to-be-encoded scene audio signal, where the scene audio signal includes an audio signal with C1 channels, and C1 is a positive integer;
an attribute information obtaining module 1002, configured to determine attribute information of a target virtual speaker based on the scene audio signal; and
an encoding module 1003, configured to encode a first audio signal in the scene audio signal and the attribute information of the target virtual speaker, to obtain a first bitstream, where the first audio signal is an audio signal with K channels in the scene audio signal, and K is a positive integer less than or equal to C1.

For example, the first audio signal includes a second audio signal.

For example, the first audio signal further includes a fourth audio signal. The fourth audio signal is an audio signal with some channels in a third audio signal.

For example, the attribute information of the target virtual speaker includes at least one of the following: location information of the target virtual speaker, a location index corresponding to the location information of the target virtual speaker, or a virtual speaker index of the target virtual speaker.

For example, the attribute information obtaining module 1002 is configured to: obtain a plurality of groups of virtual speaker coefficients corresponding to a plurality of candidate virtual speakers, where the plurality of groups of virtual speaker coefficients are in a one-to-one correspondence with the plurality of candidate virtual speakers; select the target virtual speaker from the plurality of candidate virtual speakers based on the scene audio signal and the plurality of groups of virtual speaker coefficients; and obtain the attribute information of the target virtual speaker.

For example, the attribute information obtaining module 1002 is configured to: obtain a dot product of the scene audio signal and each of the plurality of groups of virtual speaker coefficients, to obtain a plurality of dot product values, where the plurality of dot product values are in a one-to-one correspondence with the plurality of groups of virtual speaker coefficients; and select the target virtual speaker from the plurality of candidate virtual speakers based on the plurality of dot product values.

For example, the scene audio encoding apparatus further includes: a feature information obtaining module, configured to obtain feature information that corresponds to a fifth audio signal and that is in the scene audio signal, where the fifth audio signal is the third audio signal, or the fifth audio signal is an audio signal in the scene audio signal other than the second audio signal and the fourth audio signal. The encoding module 1003 is further configured to encode the feature information, to obtain a second bitstream.

For example, the feature information includes gain information.

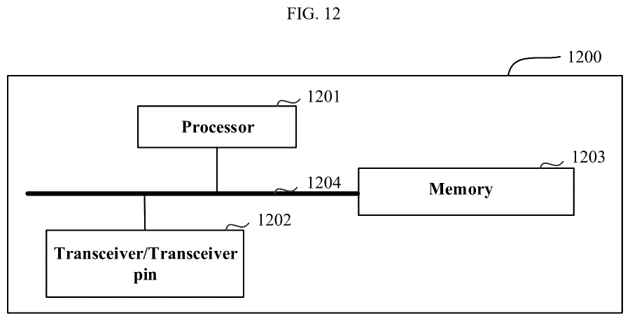

FIG. 11 is a diagram of an example structure of a scene audio decoding apparatus. The scene audio decoding apparatus in FIG. 11 may be configured to perform the decoding method in the foregoing embodiment. Therefore, for beneficial effects that can be achieved by the scene audio decoding apparatus, refer to beneficial effects in the corresponding method provided above. Details are not described herein again. The scene audio decoding apparatus may include:
a bitstream receiving module 1101, configured to receive a first bitstream;
a decoding module 1102, configured to decode the first bitstream, to obtain a first reconstructed signal and attribute information of a target virtual speaker, where the first reconstructed signal is a reconstructed signal of a first audio signal in a scene audio signal, the scene audio signal includes an audio signal with C1 channels, the first audio signal is an audio signal with K channels in the scene audio signal, C1 is a positive integer, and K is a positive integer less than or equal to C1;
a virtual speaker signal generation module 1103, configured to generate, based on the attribute information and the first reconstructed signal, a virtual speaker signal corresponding to the target virtual speaker; and
a scene audio signal reconstruction module 1104, configured to perform reconstruction based on the attribute information and the virtual speaker signal, to obtain a first reconstructed scene audio signal, where the first reconstructed scene audio signal includes an audio signal with C2 channels, and C2 is a positive integer.

For example, the scene audio decoding apparatus further includes: a signal generation module 1105, configured to generate a second reconstructed scene audio signal based on the first reconstructed signal and the first reconstructed scene audio signal. The second reconstructed scene audio signal includes an audio signal with C2 channels, and C2 is a positive integer.

For example, the signal generation module 1105 is configured to generate the second reconstructed scene audio signal based on a second reconstructed signal and a seventh audio signal when the first audio signal includes a second audio signal. The second reconstructed signal is a reconstructed signal of the second audio signal.

For example, the signal generation module 1105 is configured to: generate the second reconstructed scene audio signal based on a second reconstructed signal, a fourth reconstructed signal, and an eighth audio signal when the first audio signal includes the second audio signal and a fourth audio signal. The fourth audio signal is a partial audio signal in the third audio signal, the fourth reconstructed signal is a reconstructed signal of the fourth audio signal, the second reconstructed signal is a reconstructed signal of the second audio signal, and the eighth audio signal is a partial audio signal in the seventh audio signal.

For example, the virtual speaker signal generation module 1103 is configured to: determine, based on the attribute information of the target virtual speaker, a first virtual speaker coefficient corresponding to the target virtual speaker; and generate the virtual speaker signal based on the first reconstructed signal and the first virtual speaker coefficient.

For example, the scene audio signal reconstruction module 1104 is configured to: determine, based on the attribute information of the target virtual speaker, a second virtual speaker coefficient corresponding to the target virtual speaker; and obtain the first reconstructed scene audio signal based on the virtual speaker signal and the second virtual speaker coefficient.

For example, the bitstream receiving module 1101 is further configured to receive a second bitstream. The decoding module 1102 is further configured to decode the second bitstream, to obtain feature information that corresponds to a fifth audio signal and that is in the scene audio signal. The fifth audio signal is the third audio signal. The scene audio decoding apparatus further includes: a compensation module, configured to compensate the seventh audio signal based on the feature information.

For example, the bitstream receiving module 1101 is further configured to receive a second bitstream. The decoding module 1102 is further configured to decode the second bitstream, to obtain feature information that corresponds to a fifth audio signal and that is in the scene audio signal. The fifth audio signal is an audio signal in the scene audio signal other than the second audio signal and the fourth audio signal. The scene audio decoding apparatus further includes: a compensation module, configured to compensate an eighth audio signal based on the feature information.

For example, the feature information includes gain information.

In an example, FIG. 12 is a schematic block diagram of an apparatus 1200 according to an embodiment. The apparatus 1200 may include a processor 1201 and a transceiver/transceiver pin 1202, and optionally further includes a memory 1203.

Components of the apparatus 1200 are coupled together through a bus 1204. In addition to a data bus, the bus 1204 further includes a power bus, a control bus, and a status signal bus. However, for clear description, various types of buses in the figure are referred to as the bus 1204.

Optionally, the memory 1203 may be configured to store instructions in the foregoing method embodiments. The processor 1201 may be configured to: execute the instructions in the memory 1203, control a receiving pin to receive a signal, and control a sending pin to send a signal.

The apparatus 1200 may be the electronic device or a chip of the electronic device in the foregoing method embodiments.

All related content of the steps in the foregoing method embodiments may be cited in function descriptions of the corresponding functional modules. Details are not described herein again.

An embodiment further provides a chip. The chip includes one or more interface circuits and one or more processors. The interface circuit is configured to: receive a signal from a memory of an electronic device, and send the signal to the processor. The signal includes computer instructions stored in the memory. When the processor executes the computer instructions, the electronic device is enabled to perform the method in the foregoing embodiments. The interface circuit may be the transceiver 1202 in FIG. 12.

An embodiment further provides a computer-readable storage medium. The computer-readable storage medium stores computer instructions. When the computer instructions are run on an electronic device, the electronic device is enabled to perform the foregoing related method steps, to implement the scene audio encoding and decoding method in the foregoing embodiments.

An embodiment further provides a computer program product. When the computer program product is run on a computer, the computer is enabled to perform the foregoing related steps, to implement the scene audio encoding and decoding method in the foregoing embodiments.

An embodiment further provides a bitstream storage apparatus. The apparatus includes: a receiver and at least one storage medium. The receiver is configured to receive a bitstream. The at least one storage medium is configured to store the bitstream. The bitstream is generated according to the scene audio encoding and decoding method in the foregoing embodiments.

An embodiment provides a bitstream transmission apparatus. The apparatus includes a transmitter and at least one storage medium. The at least one storage medium is configured to store a bitstream. The bitstream is generated according to the scene audio encoding and decoding method in the foregoing embodiments. The transmitter is configured to: obtain the bitstream from the storage medium, and send the bitstream to a terminal-side device through a transmission medium.

An embodiment provides a bitstream distribution system. The system includes: at least one storage medium, configured to store at least one bitstream, where the at least one bitstream is generated according to the scene audio encoding and decoding method in the foregoing embodiments; and a streaming media device, configured to: obtain a target bitstream from the at least one storage medium, and send the target bitstream to a terminal-side device. The streaming media device includes a content server or a content delivery server.

In addition, an embodiment further provides an apparatus. The apparatus may be a chip, a component, or a module, and the apparatus may include a processor and a memory that are connected. The memory is configured to store computer-executable instructions. When the apparatus runs, the processor may execute the computer-executable instructions stored in the memory, so that the chip performs the scene audio encoding and decoding method in the foregoing method embodiments.

The electronic device, the computer-readable storage medium, the computer program product, or the chip provided in embodiments is configured to perform the corresponding method provided above. Therefore, for beneficial effects that can be achieved, refer to the beneficial effects in the corresponding method provided above. Details are not described herein.

Based on the descriptions about the foregoing implementations, a person skilled in the art may understand that, for a purpose of convenient and brief description, division into the foregoing functional modules is used as an example for illustration. In actual application, the foregoing functions may be allocated to different functional modules and implemented based on requirements. In other words, an inner structure of an apparatus is divided into different functional modules to implement all or some of the functions described above.

In the several embodiments provided disclosure, it should be understood that the disclosed apparatus and method may be implemented in other manners. For example, the described apparatus embodiment is merely an example. For example, the module or division into the units is merely logical function division and may be other division in actual implementation. For example, a plurality of units or components may be combined or integrated into another apparatus, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of embodiments.

In addition, functional units in embodiments of this disclosure may be integrated into one processing unit, each of the units may exist alone physically, or two or more units may be integrated into one unit. The integrated unit may be implemented in a form of hardware, or may be implemented in a form of a software functional unit.

Any content in embodiments and any content in a same embodiment can be freely combined. Any combination of the foregoing content falls within the scope of this disclosure.

When the integrated unit is implemented in the form of a software functional unit and sold or used as an independent product, the integrated unit may be stored in a readable storage medium. Based on such an understanding, the technical solutions of embodiments essentially, or the part contributing to some technologies, or all or some of the technical solutions may be implemented in a form of a software product. The software product is stored in a storage medium and includes several instructions for instructing a device (which may be a single-chip microcomputer, a chip, or the like) or a processor to perform all or some of the steps of the methods described in embodiments. The foregoing storage medium includes various media that can store program code, such as a universal serial bus (USB), flash drive, a removable hard disk drive, a read-only memory (ROM), a random-access memory (RAM), a magnetic disk, or an optical disc.

The foregoing describes embodiments with reference to the accompanying drawings. However, this disclosure is not limited to the foregoing example implementations. The foregoing implementations are merely examples instead of limitations. Inspired by this disclosure, a person of ordinary skill in the art may further make modifications without departing from the purposes of this disclosure and the protection scope of the claims, and all the modifications shall fall within the protection of this disclosure.

Methods or algorithm steps described in combination with the content disclosed in this embodiment may be implemented by hardware, or may be implemented by a processor by executing a software instruction. The software instruction may include a corresponding software module. The software module may be stored in a RAM, a flash memory, a ROM, an erasable programmable ROM (EPROM), an electrically erasable programmable ROM (EEPROM), a register, a hard disk, a removable hard disk, a compact disc ROM (CD-ROM), or any other form of storage medium well-known in the art. For example, a storage medium is coupled to a processor, so that the processor can read information from the storage medium and write information into the storage medium. Certainly, the storage medium may be a component of the processor. The processor and the storage medium may be disposed in an application-specific integrated circuit (ASIC).

A person skilled in the art should be aware that in the foregoing one or more examples, functions described in embodiments may be implemented by hardware, software, firmware, or any combination thereof. When the functions are implemented by software, the foregoing functions may be stored in a computer-readable medium or transmitted as one or more instructions or code in a computer-readable medium. The computer-readable medium includes a computer-readable storage medium and a communication medium, where the communication medium includes any medium that enables a computer program to be transmitted from one place to another. The storage medium may be any available medium accessible to a general-purpose or a dedicated computer. The foregoing describes embodiments with reference to the accompanying drawings. However, this disclosure is not limited to the foregoing implementations. The foregoing implementations are merely examples instead of limitations. Inspired by this disclosure, a person of ordinary skill in the art may further make modifications without departing from the purposes of this disclosure and the protection scope of the claims, and all the modifications shall fall within the protection of this disclosure.

1. A method comprising:
obtaining a scene audio signal comprising C1 channels, wherein C1 is a positive integer;
determining attribute information of a target virtual speaker based on the scene audio signal; and
encoding a first audio signal and the attribute information in the scene audio signal to obtain a first bitstream,
wherein the first audio signal comprises K channels in the scene audio signal, and
wherein K is a positive integer less than or equal to C1.

2. The method of claim 1, wherein the scene audio signal is an N1-order higher-order Ambisonics (HOA) signal comprising:
a second audio signal, wherein the second audio signal is a 0^{th}-order signal to an M^{th}-order signal in the N1-order HOA signal, and wherein M is an integer less than N1; and,
a third audio signal, wherein the third audio signal is an audio signal in the N1-order HOA signal and differs from the second audio signal, wherein C1 is equal to a square of (N1+1), N1 is a positive integer, and the first audio signal comprises the second audio signal.

3. The method of claim 2, wherein the first audio signal further comprises a fourth audio signal comprising a plurality of channels in the third audio signal.

4. The method of claim 1, wherein the attribute information of the target virtual speaker comprises at least one of:
location information of the target virtual speaker;
a location index corresponding to the location information; or
a virtual speaker index of the target virtual speaker.

5. The method of claim 1, wherein determining the attribute information comprises:
obtaining a plurality of groups of virtual speaker coefficients that is in one-to-one correspondence with a plurality of candidate virtual speakers; and
selecting the target virtual speaker from the plurality of candidate virtual speakers based on the scene audio signal and the plurality of groups of virtual speaker coefficients to obtain the attribute information.

6. The method of claim 5, wherein selecting the target virtual speaker comprises:
obtaining a dot product of the scene audio signal and each of the plurality of groups of virtual speaker coefficients values that respectively correspond to the groups of virtual speaker coefficients; and
selecting the target virtual speaker from the plurality of candidate virtual speakers based on the plurality of dot product values.

7. The method of claim 21, further comprising:
obtaining feature information that corresponds to a fifth audio signal and that is in the scene audio signal, wherein the fifth audio signal is the third audio signal or differs from the second audio signal and a fourth audio signal; and
encoding the feature information to obtain a second bitstream comprising a plurality of channels in the third audio signal.

8. The method of claim 7, wherein the feature information comprises gain information.

9. A bitstream generation method comprising:
obtaining a scene audio signal comprising an audio signal with C1 channels, wherein C1 is a positive integer;
determining attribute information of a target virtual speaker based on the scene audio signal; and
generating a first bitstream by encoding a first audio signal and the attribute information in the scene audio signal, wherein the first audio signal comprises K channels in the scene audio signal, and wherein K is a positive integer less than or equal to C1.

10. The bitstream generation method of claim 9, wherein the scene audio signal is an N1-order higher-order Ambisonics (HOA) signal comprising:
a second audio signal, wherein the second audio signal is a 0th-order signal to an M^{th}-order signal in the N1-order HOA signal, and wherein M is an integer less than N1; and
a third audio signal, wherein the third audio signal is an audio signal in the N1-order HOA signal and differs from the second audio signal, wherein C1 is equal to a square of (N1+1), N1 is a positive integer, and the first audio signal comprises the second audio signal.

11. The bitstream generation method of claim 10, wherein the first audio signal further comprises a fourth audio signal comprising a plurality of channels in the third audio signal.

12. The bitstream generation method of claim 9, wherein the attribute information of the target virtual speaker comprises at least one of:
location information of the target virtual speaker;
a location index corresponding to the location information of the target virtual speaker; or
a virtual speaker index of the target virtual speaker.

13. An electronic device comprising:
a memory comprising stored computer instructions; and
one or more processors coupled to the memory and configured to execute the computer instructions to cause the electronic device to:
obtain a scene audio signal, wherein the scene audio signal comprises an audio signal with C1 channels, and wherein C1 is a positive integer;
determine attribute information of a target virtual speaker based on the scene audio signal; and
encode a first audio signal and the attribute information in the scene audio signal to obtain a first bitstream,
wherein the first audio signal is an audio signal with K channels in the scene audio signal, and
wherein K is a positive integer less than or equal to C1.

14. The electronic device of claim 13, wherein the scene audio signal is an N1-order higher-order Ambisonics (HOA) signal comprising:
a second audio signal, wherein the second audio signal is a 0^{th}-order signal to an M^{th}-order signal in the N1-order HOA signal, and wherein M is an integer less than N1; and
a third audio signal, wherein the third audio signal is an audio signal in the N1-order HOA signal and differs from the second audio signal, wherein
C1 is equal to a square of (N1+1), N1 is a positive integer, and the first audio signal comprises the second audio signal.

15. The electronic device of claim 14, wherein the first audio signal further comprises a fourth audio signal comprising a plurality of channels in the third audio signal.

16. The electronic device of claim 13, wherein the attribute information of the target virtual speaker comprises at least one of:
location information of the target virtual speaker;
a location index corresponding to the location information of the target virtual speaker; or
a virtual speaker index of the target virtual speaker.

17. A chip comprising:
one or more interface circuits configured to:
receive, from an electronic device, a signal comprising computer instructions; and
send the signal; and
one or more processors, coupled to the one or more interface circuits and configured to receive computer instructions from the one or more interface circuit and execute the computer instructions to cause the electronic device to:
obtain a scene audio signal comprising an audio signal with C1 channels, wherein C1 is a positive integer;
determine attribute information of a target virtual speaker based on the scene audio signal; and
encode a first audio signal and the attribute information in the scene audio signal to obtain a first bitstream,
wherein the first audio signal is an audio signal with K channels in the scene audio signal, and
wherein K is a positive integer less than or equal to C1.

18. The chip of claim 17, wherein the scene audio signal is an N1-order higher-order Ambisonics (HOA) signal comprising:
a second audio signal, wherein the second audio signal is a 0^{th}-order signal to an M^{th}-order signal in the N1-order HOA signal, and wherein M is an integer less than N1; and
a third audio signal, wherein the third audio signal is an audio signal in the N1-order HOA signal and differs from the second audio signal, wherein C1 is equal to a square of (N1+1), N1 is a positive integer, and the first audio signal comprises the second audio signal.

19. The chip of claim 18, wherein the first audio signal further comprises a fourth audio signal, and wherein the fourth audio signal is an audio signal comprising a plurality of channels in the third audio signal.

20. The chip of claim 17, wherein the attribute information of the target virtual speaker comprises at least one of:
location information of the target virtual speaker;
a location index corresponding to the location information of the target virtual speaker; or
a virtual speaker index of the target virtual speaker.
